(19) United States
(12) Patent Application Publication
(10) Pub. No.: US 2022/0309172 A1
(43) Pub. Date: Sep. 29, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Toru OTSUKA, Kanagawa (JP)

(73) Assignee: FUJIFILM BUSINESS INNOVATION CORP., Tokyo (JP)

(21) Appl. No.: 17/384,255

(22) Filed: Jul. 23, 2021

(30) Foreign Application Priority Data
Mar. 26, 2021 (JP) 2021-053662

(51) Int. Cl. G06F 21/62; G06K 9/00; G06K 9/72; H04N 1/44

(52) U.S. Cl. CPC G06F 21/6209; G06K 9/00463; G06K 9/72; H04N 1/444; G06K 9/00469; G06F 2221/2141; G06F 2221/2151

(57) ABSTRACT

An information processing apparatus includes: a processor configured to: extract a first feature word from a first document to which both a first user and a second user have an access right; extract contents associated with an operation log of the first user; and control access of the second user to the contents by using the first feature word.

### CROSS-REFERENCE TO RELATED APPLICATIONS

This application is based on and claims priority under 35 USC 119 from Japanese Patent Application No. 2021-053662 filed Mar. 26, 2021.

### BACKGROUND

### (i) Technical Field

The present disclosure relates to an information processing apparatus and a non-transitory computer readable medium.

### (ii) Related Art

JP-A-2011-039637 discloses a document management device in which at least one or more keywords used for authentication are extracted as authentication keywords from one or more document files that are the access targets, a correct answer key is set from the extracted authentication keywords, multiple keys including this correct answer key are created, and access is permitted to a user who requests the access to the one or more document files by causing the user to select the correct answer key from the multiple keys including this correct answer key.

### SUMMARY

A system (hereinafter, referred to as a “document management system”) that manages a document file (hereinafter, referred to as a “document”) controls whether to permit access base on the access right.

The access to the contents related to a document often needs to be controlled. For example, the access to a transmitted/received e-mail and message and the access to a browsed website in connection with a document often needs to be controlled.

However, extracting all the contents related to a specific user requires enormous number of extracted contents, which results in increase of the burden required for confirming the contents. In addition, the extraction result also includes the contents to which access has to be restricted.

Aspects of non-limiting embodiments of the present disclosure relate to reducing the burden on a user who browses the website as compared with a case where access is permitted to all the contents relevant to the document to which a specific user has an access right.

Aspects of certain non-limiting embodiments of the present disclosure address the above advantages and/or other advantages not described above. However, aspects of the non-limiting embodiments may not be required to address the advantages described above, and aspects of the non-limiting embodiments of the present disclosure may not address the advantages described above.

According to an aspect of the present disclosure, there is provided an information processing apparatus including: a processor configured to: extract a first feature word from a first document to which both a first user and a second user have an access right; extract contents associated with an operation log of the first user; and control access of the second user to the contents by using the first feature word.

### BRIEF DESCRIPTION OF THE DRAWINGS

Exemplary embodiments of the present disclosure will be described in detail based on the following figures, wherein:

FIG. 1 is a diagram illustrating the conceptual configuration of an information processing system assumed in a first exemplary embodiment;

FIG. 2 is a diagram illustrating an example of the hardware configuration of a takeover support server;

FIG. 3 is a diagram illustrating the functional configuration of a user terminal used in the first exemplary embodiment;

FIG. 4 is a diagram illustrating the functional configuration of the takeover support server used in the first exemplary embodiment;

FIG. 5 is a diagram illustrating a processing operation related to task takeover in the first exemplary embodiment;

FIG. 6 is a diagram illustrating an example of an operation log recorded for Ms. A who is in charge of a task AA and a task BB;

FIG. 7 is a chart illustrating an example of operation log data stored in an operation log server;

FIG. 8 is a diagram illustrating a screen example when Mr. B as the takeover destination designates a user to be a takeover source;

FIG. 9 is a diagram illustrating a scene in which one of tasks that Ms. A is in charge of is taken over to Mr. B;

FIG. 10 is a diagram illustrating the relationship between a document and an access right after the task takeover;

FIG. 11 is a diagram illustrating documents and contents related to a Ms. A's operation log;

FIG. 12 is a diagram illustrating a state in which a feature word is extracted from a document α to which both Ms. A as the takeover source user and Mr. B as the takeover destination user have an access right;

FIG. 13 is a diagram illustrating control of browsing of the relevant contents;

FIG. 14 is a diagram illustrating a screen example of the relevant contents of Ms. A as the takeover source;

FIG. 15 is a diagram illustrating the functional configuration of a takeover support server used in a second exemplary embodiment;

FIG. 16 is a diagram illustrating a processing operation related to task takeover in the second exemplary embodiment;

FIG. 17 is a diagram illustrating an example of an operation log recorded for Ms. A who is in charge of the task AA and the task BB;

FIG. 18 is a diagram illustrating a scene in which one of tasks that Ms. A is in charge of is taken over by Mr. B;

FIG. 19 is a diagram illustrating the relationship between a document and an access right after the task takeover;

FIG. 20 is a diagram illustrating documents and contents related to a Ms. A's operation log;

FIG. 21 is a diagram illustrating a state in which a feature word is extracted from a document α, a document β, and a document γ to which Ms. A as the takeover source user has an access right;

FIG. 22 is a diagram illustrating the relationship between a feature word list and a feature word used for extracting the relevant contents;

FIG. 23 is a diagram illustrating control of browsing of the relevant contents;

FIG. 24 is a diagram illustrating the functional configuration of a takeover support server used in a third exemplary embodiment;

FIG. 25 is a diagram illustrating a processing operation related to task takeover in the third exemplary embodiment;

FIG. 26 is a diagram illustrating a state in which a feature word count list #1 is generated from a document α and a document γ to which both Ms. A as the takeover source user and Mr. B as the takeover destination user have an access right;

FIG. 27 is a diagram illustrating a specific example of narrowing down by a feature word narrowing unit;

FIG. 28 is a diagram illustrating control of browsing of the relevant contents;

FIG. 29 is a diagram illustrating the functional configuration of a takeover support server used in a fourth exemplary embodiment;

FIG. 30 is a diagram illustrating a processing operation related to task takeover in the fourth exemplary embodiment;

FIG. 31 is a diagram illustrating a scene in which one of tasks that Ms. A is in charge of is taken over by Mr. B;

FIG. 32 is a diagram illustrating a state in which a feature word count list #1 is generated from a document α and a document γ to which both Ms. A as the takeover source user and Mr. B as the takeover destination user have an access right;

FIG. 33 is a diagram illustrating the functional configuration of a takeover support server used in a fifth exemplary embodiment;

FIG. 34 is a diagram illustrating a processing operation related to task takeover in the fifth exemplary embodiment; and

FIG. 35 is a diagram illustrating control of browsing of the relevant contents.

### DETAILED DESCRIPTION

Hereinafter, exemplary embodiments of the present disclosure will be described with reference to the drawings.

### First Exemplary Embodiment

### <Example of System>

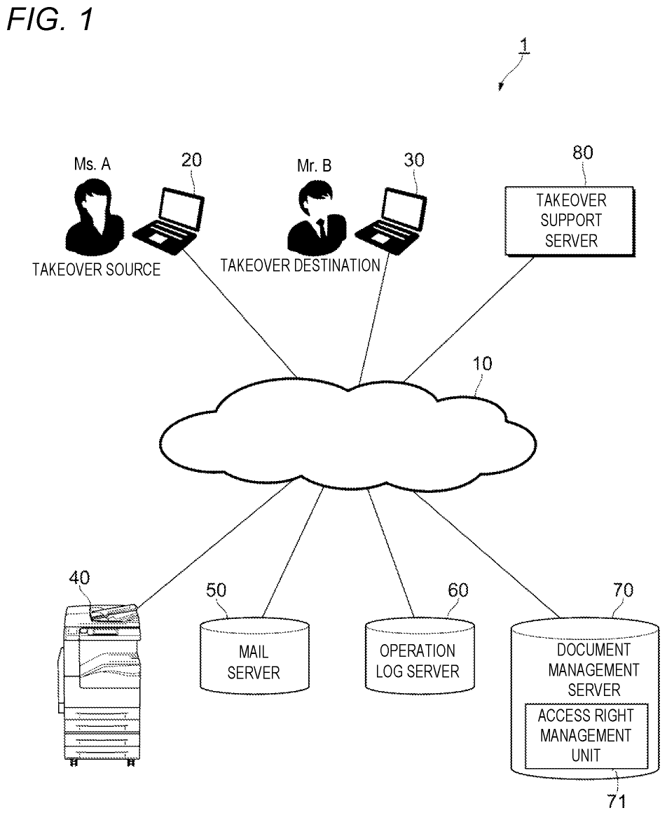

FIG. 1 is a diagram illustrating the conceptual configuration of an information processing system 1 assumed in a first exemplary embodiment.

The information processing system 1 illustrated in FIG. 1 is configured with plural terminals connected to a network 10.

The information processing system 1 illustrated in FIG. 1 includes terminals, for example, a user terminal 20 operated by Ms. A and a user terminal 30 operated by Mr. B, an image forming apparatus 40 including a printing engine and a scanner, a mail server 50 that transmits and receives an e-mail, an operation log server 60 that stores a log (hereinafter, referred to as an “operation log”) that records the operation of a terminal by a user, a document management server 70 that manages a document uploaded by a user, and a takeover support server 80 that supports task takeover between users.

The network 10 in the present exemplary embodiment is, for example, a LAN (Local Area Network), the Internet, or a cloud network.

In the case of FIG. 1, the user terminals 20 and 30 are laptop computers. In addition, the user terminals 20 and 30 may be desktop computers or tablet computers. Further, the user terminals 20 and 30 may be smartphones or wearable computers such as smart glasses and smart watches.

The user terminals 20 and 30 have a function of uploading, for example, a document generated by a user, a document edited by a user, and a document acquired by a user from another terminal to the document management server 70.

Information that identifies a user is linked with the uploaded document. For example, a user's account, employee number, and e-mail address are used for the information that identifies the user.

A document in the present exemplary embodiment includes, for example, an office document created by office software or other application programs, an e-mail, a photograph, and various types of images.

The office document includes, for example, texts, figures, photographs, tables, data sheets, and databases. Further, the image is not limited to a still image, but also includes a moving image. The photograph is included in the image.

In addition, the user terminals 20 and 30 are provided with a function of recording an operation log. The operation log in the present exemplary embodiment refers to, for example, a log of operation related to a document. The log of operation related to a document includes a log of transmission/reception of an e-mail and message, a log of upload and download of a document, and a log of browsing of a web site.

The user terminals 20 and 30 in the present exemplary embodiment have a function of uploading the operation log to the operation log server 60. The uploading of the operation log is executed periodically, for example, according to a predetermined schedule.

However, the uploading of the operation log may be executed based on a user's instruction or an instruction from an external terminal. The external terminal includes a terminal operated by a system administrator, and the takeover support server 80.

Further, the user terminals 20 and 30 may transmit the operation log to the operation log server 60 based on a request from the operation log server 60.

In the example of FIG. 1, two users, that is, Ms. A as the predecessor of a task to be taken over, and Mr. B as the successor of the task to be taken over, are represented as the user terminals 20 and 30, but the number of computers constituting the information processing system 1 is not limited to two.

In the present exemplary embodiment, Ms. A is an example of a “first user”, and Mr. B is an example of a “second user”.

The image forming apparatus 40 includes a function of printing text or an image on a sheet, a function of reading image data of the original document, a function of generating a copy of the original document, and a function of transmitting and receiving a facsimile.

The upper part of the body of the image forming apparatus 40 illustrated in FIG. 1 is provided with a mechanism for transferring documents one by one to a position at which image data is input. This type of mechanism is called, for example, an auto document feeder (ADF).

The image data of the manuscript is not limited to image data optically input by the image forming apparatus 40, but may be image data acquired from a recording medium connected to the body of the image forming apparatus 40, or from an external information terminal. The image data mentioned here is an example of a document. The image forming apparatus 40 according to the present exemplary embodiment is also provided with a function of uploading a document such as optically input image data to the document management server 70.

Information that identifies a user is linked with the uploaded document. In the present exemplary embodiment, the information that identifies the user may be any information that may identify Ms. A who is the predecessor of the task to be taken over. For example, a user's account, employee number, and e-mail address are used for the information that identifies the user.

When user authentication is required at the start of an operation, information that identifies an authenticated user is linked with the uploaded document.

When user authentication is not required at the start of an operation, information that identifies a user, which is input at the time of upload, is linked with the uploaded document.

An operation log related to the authenticated user is uploaded from the image forming apparatus 40 to the operation log server 60.

In the example of FIG. 1, the number of image forming apparatuses 40 is one, but the number of image forming apparatus 40 constituting the information processing system 1 is not limited to one.

The mail server 50 is a server that implements transmission and reception of an e-mail related to a user of a mail service.

The mail server 50 in the present exemplary embodiment includes a Simple Mail Transfer Protocol (SMTP) server that manages the transmission of the e-mail, a Post Office Protocol 3 (POP3) server, and a Domain Name System (DNS) server.

The mail server 50 in the present exemplary embodiment cooperates with the takeover support server 80 that supports the task takeover.

Therefore, when an e-mail related to a specific user is requested from the takeover support server 80, the mail server 50 transmits the corresponding e-mail to the takeover support server 80.

The mail server 50 may be a short message service (SMS) server operated by a carrier that provides a telephone service, or a web mail server operated by a company that provides a web mail service.

The SMS server and the web mail server participating in the information processing system 1 also transmit a message related to a specific user to the takeover support server 80 according to a request from the takeover support server 80.

The operation log server 60 is a server that acquires the operation log of the user terminals 20 and 30 that are under control, from the same terminals and stores the operation log. It is assumed that the operation log is uploaded from the user terminals 20 and 30, but the operation log server 60 may request the transmission of the operation log.

The operation log server 60 also cooperates with the takeover support server 80 that supports the task takeover. Therefore, when an operation log related to a specific user is requested from the takeover support server 80, the operation log server 60 transmits the corresponding e-mail to the takeover support server 80.

The document management server 70 is a so-called file server and is used for storing a document and sharing a document.

The document management server 70 in the present exemplary embodiment cooperates with the user terminals 20 and 30, the image forming apparatus 40, and the takeover support server 80.

The document management server 70 in the present exemplary embodiment may set an access right for the access to a document under management. The access right is managed by, for example, a user's account, employee number, and e-mail address.

The access right includes, for example, a reference right, an editorial right, and a management right.

The reference right is the right to read a document.

The editorial right is the right to edit or change the content of a document.

The management right is the right granted to a system and a work administrator.

In the present exemplary embodiment, the editorial right includes the reference right.

In addition, the management right includes the editorial right.

In the present exemplary embodiment, the document management server 70 manages the access right of each user by an access right management unit 71. The management of the access right by the access right management unit 71 includes granting, deleting, and changing the access right.

The access right is granted by a system and a work administrator.

In the present exemplary embodiment, the access right is granted to a specific user, for example, on a task or document basis.

In the case of the task basis, all documents in a folder corresponding to a task to be taken over are the objects.

In the present exemplary embodiment, a document to which the access right is granted is limited to a document managed in association with a task in the document management server 70. The granted access right is one of the reference right, the editorial right, and the management right.

The access right is deleted on a task or document basis.

The change in the access right includes not only a change in the content of the access right but also a change in the task or document to which the access right is granted.

The takeover support server 80 is a server that provides a service that supports the task takeover between users. The takeover support server 80 is an example of an information processing apparatus.

In the present exemplary embodiment, a user as the takeover source is “Ms. A” and a user as the takeover destination is “Mr. B”.

In this case, as for a task to be taken over, the takeover support server 80 allows Mr. B to browse documents uploaded from the user terminal 20 to the document management server 70, documents downloaded, e-mail transmitted/received in connection with the task, and websites browsed in connection with the task by Ms. A.

In the present exemplary embodiment, a document, an e-mail, and a web site are collectively referred to as “contents”. That is, in the present exemplary embodiment, the contents include not only a document managed by the document management server 70, but also an e-mail and a website.

However, the contents may be limited to an e-mail and a website that are not managed by the document management server 70.

The purpose of the present exemplary embodiment is to provide Mr. B with information such as an e-mail transmitted/received and a web site browsed in connection with a task to be taken over. In this sense, the contents may be limited to the e-mail and the web site.

However, from the standpoint of Mr. B, who takes over the task, it is not practical to distinguish between a document to which the access right is granted and an e-mail and a web site to which the access right is not granted.

In the present exemplary embodiment, it may be referred to as the “contents” including the documents managed by the document management server 70.

A service provided by the takeover support server 80 may be used not only for the task takeover but also for checking a task of a specific user.

### <Hardware Configuration of Terminal>

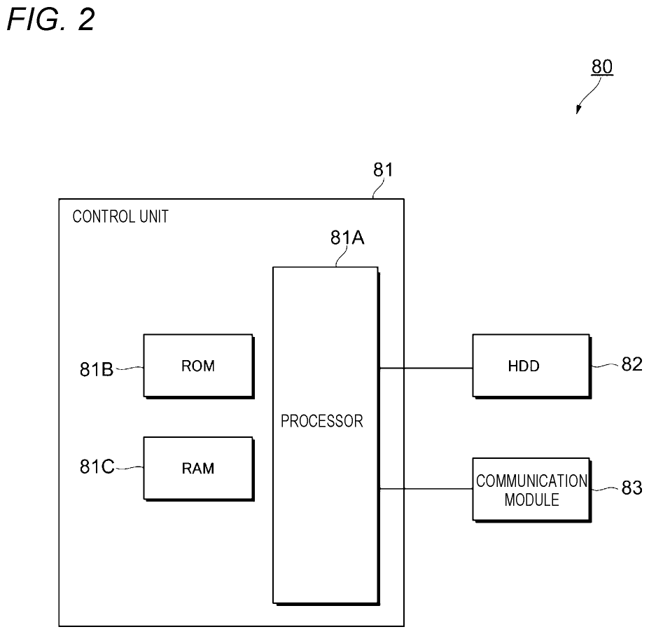

FIG. 2 is a diagram illustrating an example of the hardware configuration of the takeover support server 80.

The takeover support server 80 illustrated in FIG. 2 includes a control unit 81, an HDD (hard disk drive) 82, and a communication module 83.

The control unit 81 includes a processor 81A, a ROM 81B, and a RAM 81C.

The processor 81A is configured with, for example, a CPU. The processor 81A implements various functions through the execution of a program.

BIOS is stored in the ROM 81B. The RAM 81C is also used as an execution area.

The hard disk drive 82 is an auxiliary storage device and stores an operating system and an application program. A takeover support service in the present exemplary embodiment is implemented through the execution of the application program.

A semiconductor memory may be used instead of the hard disk drive 82.

The communication module 83 is used for communication with an external terminal.

The hardware configurations of the mail server 50, the operation log server 60, and the document management server 70 are substantially the same as the hardware configurations illustrated in FIG. 2.

Further, the hardware configuration of the user terminals 20 and 30 adds a display and a device that receives a user's operation to the hardware configuration illustrated in FIG. 2. For example, a mouse, a keyboard, or a capacitive type touch screen is used for the device that receives the user's operation.

### <Functional Configuration of Terminal>

### <Functional Configuration of User Terminal>

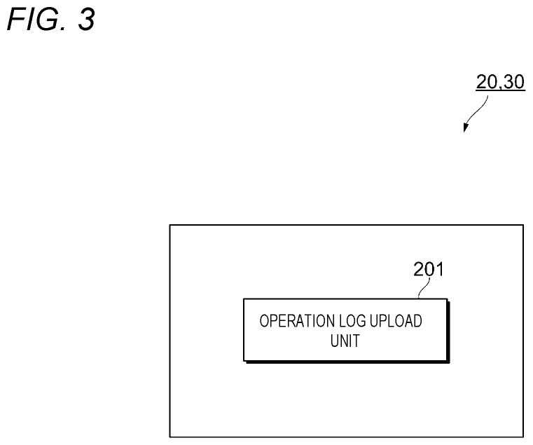

FIG. 3 is a diagram illustrating the functional configuration of the user terminals 20 and 30 used in the first exemplary embodiment. FIG. 3 illustrates only a function related to the takeover support service.

The user terminals 20 and 30 are provided with a function for uploading an operation log (hereinafter, referred to as an “operation log upload unit 201”).

The operation log upload unit 201 is implemented through the execution of the application program by the processor.

The operation log upload unit 201 implements a function of collecting operation logs stored in the user terminals 20 and 30 and uploading the logs to the operation log server 60 (see, e.g., FIG. 1).

The operation log upload unit 201 in the present exemplary embodiment uploads the operation log according to predetermined conditions. The upload may be performed, for example, regularly or periodically. In addition, when the operation log upload unit 201 is powered-on, non-uploaded operation logs may be uploaded together.

When the user terminals 20 and 30 are always powered-on, the operation log may be uploaded during the night time.

Further, the operation log upload unit 201 may transmit an undelivered operation log according to an instruction from a user or an instruction from a cooperating external terminal.

### <Functional Configuration of Takeover Support Server>

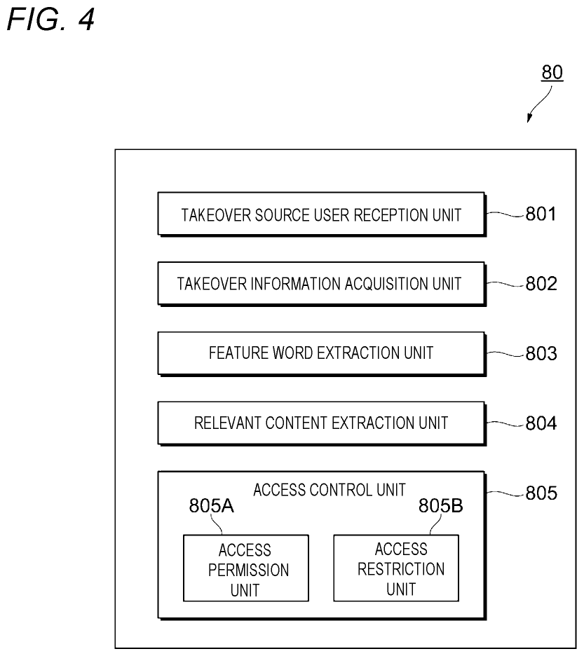

FIG. 4 is a diagram illustrating the functional configuration of the takeover support server 80 used in the first exemplary embodiment.

The takeover support server 80 has a function of receiving a designation of a user to be a takeover source (hereinafter, referred to as a “takeover source user reception unit 801”), a function of acquiring information to be taken over (hereinafter, referred to as a “takeover information acquisition unit 802”), a function of extracting a feature word from the acquired information (, hereinafter, referred to as a “feature word extraction unit 803”), a function of extracting the contents relevant to the user who is the takeover source by using the extracted feature word (hereinafter, a “relevant content extraction unit 804”), and a function of controlling access of a third party to the relevant contents (hereinafter, referred to as an “access control unit 805”).

Each function is implemented through the execution of an application program by the processor 81A (see, e.g., FIG. 2).

The takeover source user reception unit 801 displays a screen for takeover on the display of the user terminal 30 (see, e.g., FIG. 1) and receives the designation of the user who is the takeover source. In the present exemplary embodiment, “Ms. A” is designated as the user who is the takeover source. The user who is the takeover source may be narrowed down by a task, a period, and a keyword.

When “Ms. A” is specified as the takeover source, the takeover information acquisition unit 802 acquires an operation log related to “Ms. A” from the operation log server 60 (see, e.g., FIG. 1).

In addition, the takeover information acquisition unit 802 acquires a document to which the user designated as the takeover source has or had an access right, and the contents linked with the operation log of the user designated as the takeover source, as “takeover information”.

The document mentioned here includes both a document uploaded by “Ms. A” to the document management server 70 and a document downloaded by “Ms. A” from the document management server 70.

In addition, the contents include an e-mail and a browses web site.

The feature word extraction unit 803 extracts a feature word from the document or contents acquired by the takeover information acquisition unit 802.

For example, term frequency-inverse document frequency (TF-IDF), support vector machine (SVM), and KeyGraph are used for the extraction of the feature word. In addition, the feature word may be extracted by using a dictionary in which words and phrases to be used as feature words are registered in advance.

The feature word extraction unit 803 in the present exemplary embodiment extracts the feature word from a document to which both the takeover source “Ms. A” and the takeover destination “Mr. B” have the access right. This document is an example of a “first document”, and the extracted feature word is an example of a “first feature word”.

The access right mentioned here is assumed to be more than the reference right. Therefore, when the access right permits to only the document management server 70 and does not allow referencing the content of the document, the document is excluded from the candidate documents from which the feature word is to be extracted. In the present exemplary embodiment, the reference right is included in the editorial right and the management right. For this reason, a document to which an access right including the editorial right and the management right is granted is included in the objects from which the feature word is to be extracted.

In the present exemplary embodiment, the extraction of the feature word by the feature word extraction unit 803 is executed at the timing designated by the user of the takeover source. However, the extraction of the feature word may be executed as a batch process at night or the like.

The relevant content extraction unit 804 extracts documents and contents including the extracted feature word, as the relevant contents.

Including the document in the relevant contents is to reduce the risk of takeover omission even when the access right to “Mr. B” is granted individually for each document or when there is a document that needs to be included in the object to be taken over separately from a folder for a task to be taken over.

However, it is premised that the takeover destination “Mr. B” also has the access right to the document included in the relevant contents.

The access control unit 805 controls access of “Mr. B” to the takeover information about “Ms. A”.

Specifically, the access control unit 805 controls the contents that permits access by “Mr. B” and the contents that restricts access by “Mr. B”. Here, restricting the access means not permitting access.

In the present exemplary embodiment, a function of permitting the access to the contents is referred to as an access permission unit 805A, and a function of restricting the access to the contents is referred to as an access restriction unit 805B.

As a function of the access control unit 805, information taken over from “Ms. A”, that is, the relevant contents, is displayed on the display of the user terminal 30 operated by “Mr. B”.

### <Processing Operation>

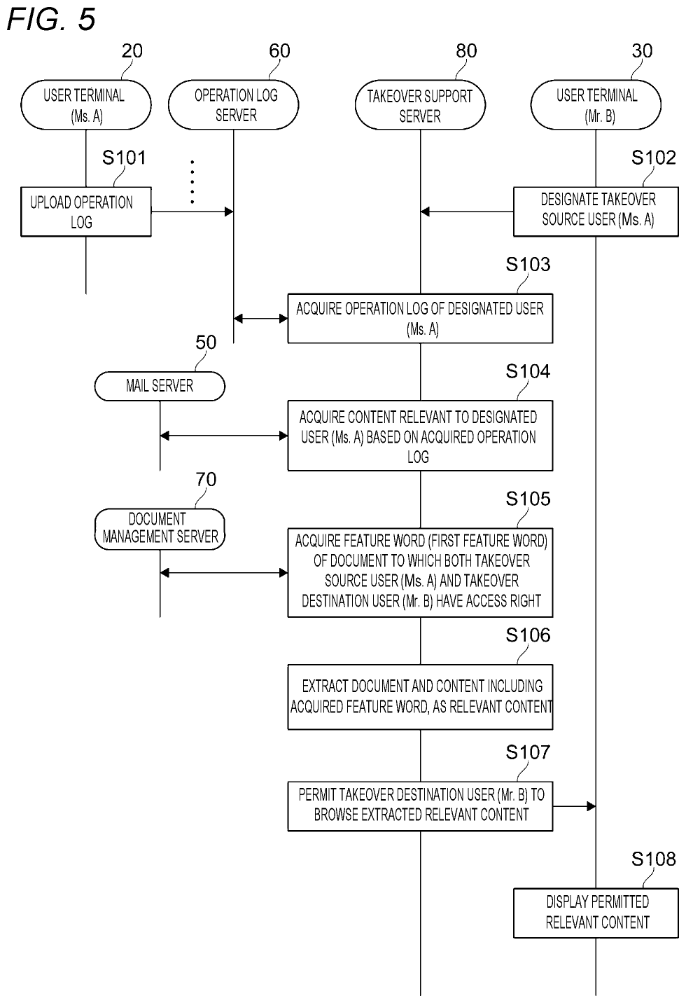

FIG. 5 is a diagram illustrating a processing operation related to task takeover in the first exemplary embodiment. In FIG. 5, symbol S is denoted in the sense of a step.

In the present exemplary embodiment, the task takeover is executed, for example, after Ms. A retires. However, the task takeover may be executed while Ms. A, who is retiring, is still working.

However, Ms. A as the task takeover source does not have to retire. For example, in the case of Ms. A's transfer, vacation, change of a task in charge, and the like, the task will be taken over.

The user terminals 20 and 30 connected to the information processing system 1 upload the operation log to the operation log server 60 regardless of the takeover (step 101).

In the example of FIG. 5, the upload of the operation log by the user terminal 20 operated by Ms. A as the takeover source is illustrated. As described above, the upload of the operation log is executed a predetermined timing.

Next, Mr. B taking over the task from Ms. A designates a takeover source user (Ms. A) with respect to the takeover support server 80 through the user terminal 30 (step 102).

At the point of time when Mr. B designates the takeover source user, it is assumed that the user B is granted with the access right to the task taken over from Ms. A and a document uploaded or downloaded by Ms. A for the task.

Further, the access right granted to Mr. B do not have to be all of the access rights granted to Ms. A. For example, it may be only for a specific task or only for a specific document.

When receiving the designation of a user on the takeover screen, the takeover support server 80 accesses the operation log server 60 to acquire the operation log of the designated user (step 103).

Next, the takeover support server 80 acquires the contents relevant to the designated user based on the acquired operation log (step 104). In the example of FIG. 5, an e-mail transmitted/received by Ms. A is acquired from the mail server 50. At this step, the relationship with the task to be taken over does not matter.

Next, the takeover support server 80 acquires a feature word of a document to which both the takeover source user and the takeover destination user have the access right (step 105). The feature word here is the “first feature word”.

The takeover destination user is specified as a user who designates the takeover source user in step 102. A feature word is acquired from only the document to which both Ms. A as the takeover source user and Mr. B as the takeover destination user have the access right. This is because it is highly likely that a document to which Mr. B does not have the access right is not a document to be taken over. In other words, this is to exclude the contents relevant to the document to which Mr. B does not have the access right, from the object to be taken over.

When the feature word is acquired, the takeover support server 80 extracts documents and contents including the acquired feature word, as the relevant contents (step 106). Specifically, an e-mail and a web site containing the feature word of the document to be taken over are extracted as the relevant contents. The e-mail and the website are not managed by the document management server 70, but contain important information that supplements the content written in the document. For example, it is possible to take over the content of an e-mail exchanged with another person in charge or an e-mail exchanged with a customer.

In addition, by using the feature word extracted from the document to be taken over, the relevant contents not relevant to the object to be taken over will not be available for browsing by Mr. B.

Next, the takeover support server 80 permits the takeover destination user to browse the extracted relevant contents (step 107).

The permitted relevant contents are transmitted from the takeover support server 80 to the user terminal 30. As a result, the user terminal 30 displays the permitted relevant contents on the display (step 108).

### SPECIFIC EXAMPLE

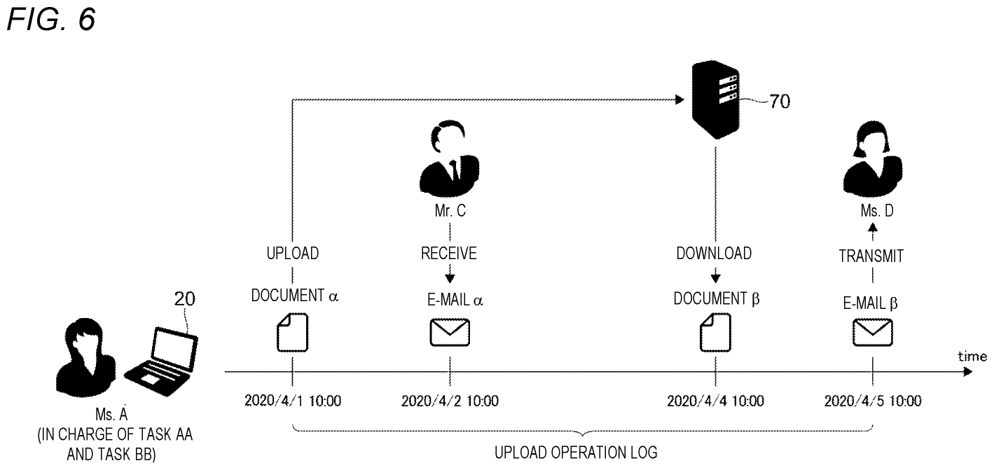

Hereinafter, specific examples of the processing operation described with reference to FIG. 5 will be described with reference to FIGS. 6 to 14.

FIG. 6 is a diagram illustrating an example of the operation log recorded for Ms. A who is in charge of a task AA and a task BB.

In the case of FIG. 6, a document α and an e-mail α are related to the task AA, and a document β and an e-mail β are related to the task BB.

In the case of FIG. 6, Ms. A uploads the document α to the document management server 70 at 10:00 on Apr. 1, 2020.

Ms. A receives the e-mail α from Mr. C at 10:00 on Apr. 2, 2020.

Ms. A downloads the document β from the document management server 70 at 10:00 on Apr. 4, 2020.

Ms. A transmits the e-mail β to Ms. D at 10:00 on Apr. 5, 2020.

These operations by Ms. A are stored in the user terminal 20 as an operation log.

The user terminal 20 uploads the operation log to the operation log server 60.

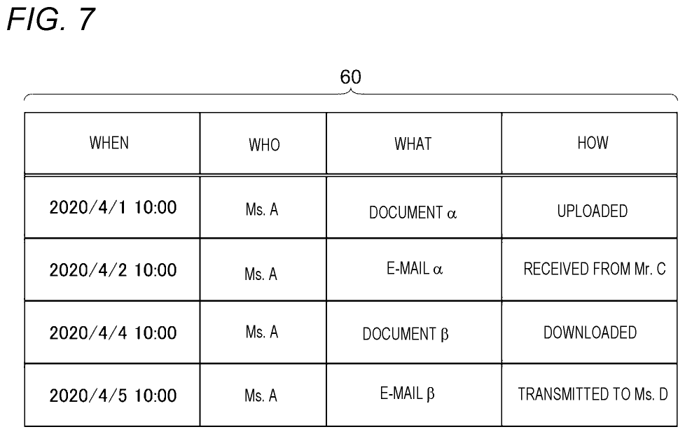

FIG. 7 is a chart illustrating an example of data of the operation log stored in the operation log server 60 (see, e.g., FIG. 1).

In the operation log server 60, the content of the uploaded operation log is managed according to items of “when”, “who”, “what”, and “how”.

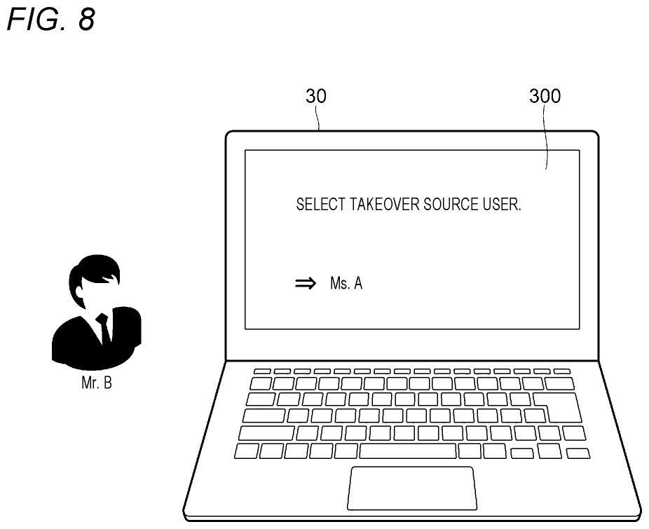

FIG. 8 is a diagram illustrating a screen example when Mr. B as the takeover destination designates a user to be a takeover source.

Mr. B taking over the task accesses the takeover support server 80 (see, e.g., FIG. 1) through the user terminal 30 and displays a screen 300 for selecting the takeover source user.

In the present exemplary embodiment, Mr. B designates Ms. A as the takeover source user.

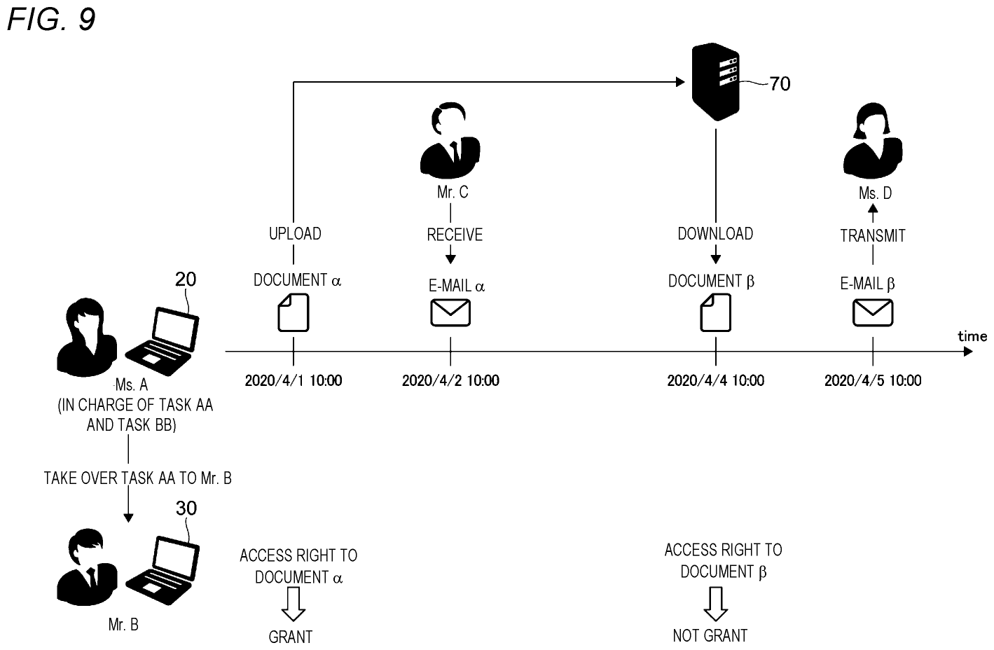

FIG. 9 is a diagram illustrating a scene in which one of tasks that Ms. A is in charge of is taken over to Mr. B.

In FIG. 9, of the task AA and the task BB that Ms. A is in charge of, only the task AA is taken over to Mr. B.

With this takeover, Mr. B is granted with the access right to the document α relevant to the task AA. Meanwhile, the access right of the document β relevant to the task BB is not granted to Mr. B.

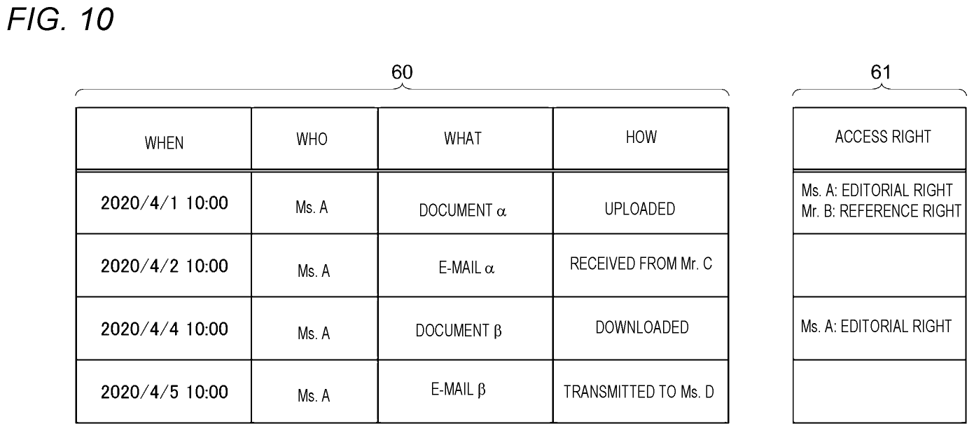

FIG. 10 is a diagram illustrating the relationship between a document and an access right after task takeover. In FIG. 10, elements corresponding to those in FIG. 7 are denoted by the corresponding reference numerals.

FIG. 10 is a chart illustrating the content of an access right 61 granted to a user in association with the operation log stored in the operation log server 60.

In the case of FIG. 10, the document α is granted with the “editorial right” to Ms. A and the “reference right” to Mr. B.

Meanwhile, the document β is granted with the “editorial right” only to Ms. A. This is because the task BB is not to be taken over to Mr. B.

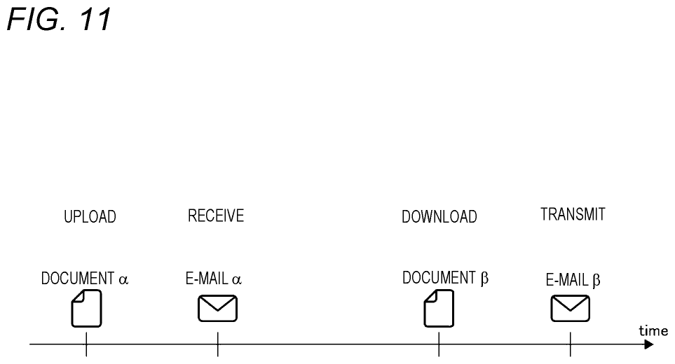

FIG. 11 is a diagram illustrating documents and contents relevant to the operation log of Ms. A. In FIG. 11, elements corresponding to those in FIG. 9 are denoted by the corresponding reference numerals.

In the present exemplary embodiment, the operation log includes four operations: one “upload” operation, one “download” operation, one “receive e-mail” operation, and one “transmit e-mail” operation.

Further, the document α and the document β are illustrated as corresponding documents, and the e-mail α and the e-mail β are illustrated as corresponding contents.

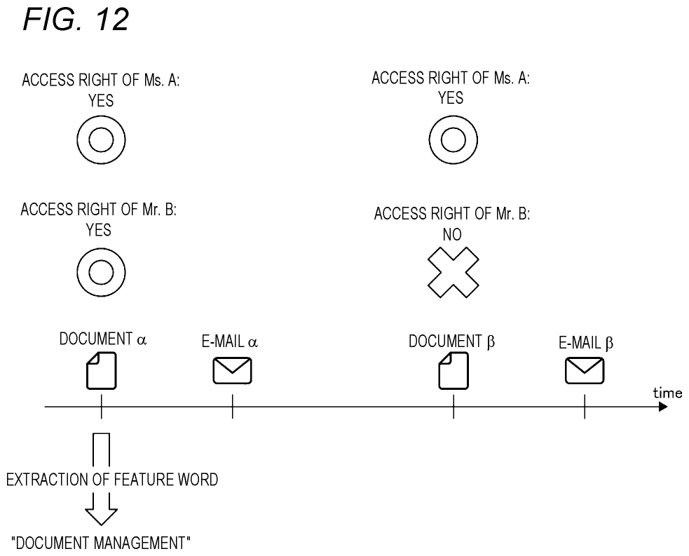

FIG. 12 is a diagram illustrating a state in which a feature word is extracted from the document α to which both Ms. A as the takeover source user and Mr. B as the takeover destination user have the access right.

In the case of FIG. 12, “document management” is extracted as the feature word from the document α.

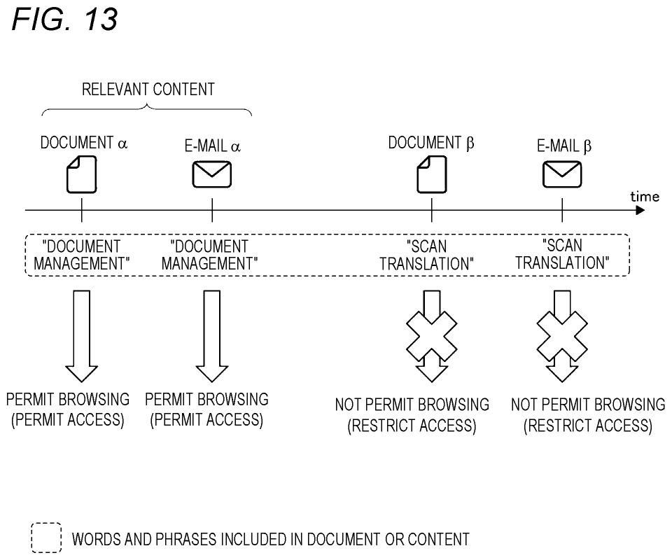

FIG. 13 is a diagram illustrating control of browsing of the relevant contents. In the case of FIG. 13, “document management” is included in the document α and the e-mail α, and “scan translation” is included in the document β and the e-mail β.

Since the feature word extracted from the document α to which both Ms. A and Mr. B have the access right is “document management”, the document α and the e-mail α are extracted as the relevant contents.

As a result, among the document α, the e-mail α, the document β, and the e-mail β extracted from the operation log of Ms. A, the browsing of the document α and the e-mail α is permitted. Meanwhile, the browsing of the document β and the e-mail β is not permitted. The phrase “the browsing not permitted” means the restriction of access.

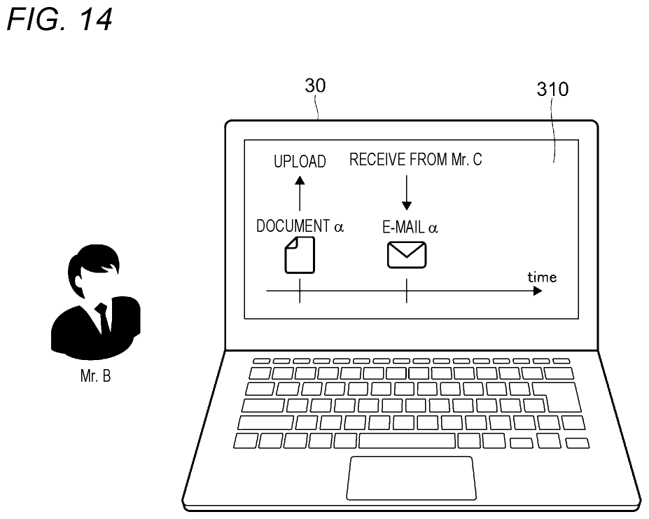

FIG. 14 is a diagram illustrating a screen example of the relevant contents of Ms. A as the takeover source.

The relevant contents of the task AA to be taken over are displayed as a screen 310 on the user terminal 30 operated by Mr. B to whom the task is taken over.

In the example of FIG. 14, as the relevant contents, the existence of the uploaded document α and the existence of the e-mail α received from Mr. C are displayed in time series.

In the present exemplary embodiment, the existence of the e-mail α is also taken over to Mr. B.

Further, Mr. B may confirm through the screen 310 that the e-mail α is the e-mail received from Mr. C.

In addition, since Mr. B does not have the access right to the document β of the task BB that Ms. A is in charge of, the document β and the e-mail β are not displayed on the user terminal 30 operated by Mr. B. As a result, the screen 310 does not include the relevant contents that are not related to the task takeover. In other words, it is possible to reduce the number of relevant contents displayed on the screen 310. Therefore, it becomes easy for Mr. B taking over the task to browse the information.

Further, since the document β and the e-mail β are not displayed on the screen 310, the information that does not need to be seen or should not be seen by Mr. B is excluded from the objects available for browsing by Mr. B.

Further, since the extracted relevant contents are displayed on the screen 310 in time series, Mr. B may know that the e-mail α has been received after the upload of the document α. For example, when there are plural e-mails that require confirmation, Mr. B will be able to confirm the transmitted/received e-mails in time series. This function makes it easier to understand the contents to be taken over, thereby making the takeover operation efficient.

### Second Exemplary Embodiment

The present exemplary embodiment also assumes the information processing system 1 illustrated in FIG. 1.

The present exemplary embodiment is different from the first exemplary embodiment in terms of a part of the functions of the takeover support server 80 (see, e.g., FIG. 1).

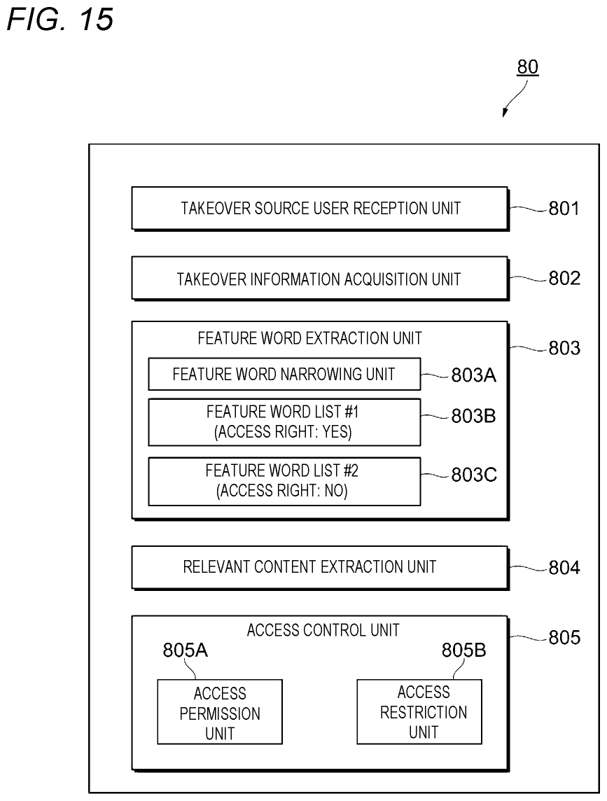

FIG. 15 is a diagram illustrating the functional configuration of the takeover support server 80 used in the second exemplary embodiment. In FIG. 15, elements corresponding to those in FIG. 4 are denoted by the corresponding reference numerals.

The takeover support server 80 used in the present exemplary embodiment is different from the first exemplary embodiment in that the feature word extraction unit 803 has a feature word narrowing unit 803A.

The feature word narrowing unit 803A uses two types of feature word lists 803B and 803C to narrow down feature words used for extracting the relevant contents.

The feature word list 803B is a list of feature words (hereinafter, referred to as a “feature word list #1”) extracted from a document to which both Ms. A as the takeover source and Mr. B as the takeover destination, have the access right.

The feature word list 803C is a list of feature words (hereinafter, referred to as a “feature word list #2”) extracted from a document to which Ms. A as the takeover source has the access right but Mr. B as the takeover destination does not have the access right. The document used to create the feature word list #2 is an example of a “second document”, and the extracted feature word is an example of a “second feature word”.

That is, the feature word narrowing unit 803A excludes the second feature word from the first feature word so that the feature word used for extracting the relevant contents does not include the second feature word.

In the case of the first exemplary embodiment, the relevant contents are extracted by using the first feature word as it is, but when the second feature word is included in the first feature word, a document to which Mr. B does not have the access right or the contents relevant to the document may be included in the relevant contents.

However, in the present exemplary embodiment, since the second feature word is excluded from the first feature word in advance, it is possible to exclude the document to which Mr. B does not have the access right and its relevant contents from the takeover information of Mr. B.

### <Processing Operation>

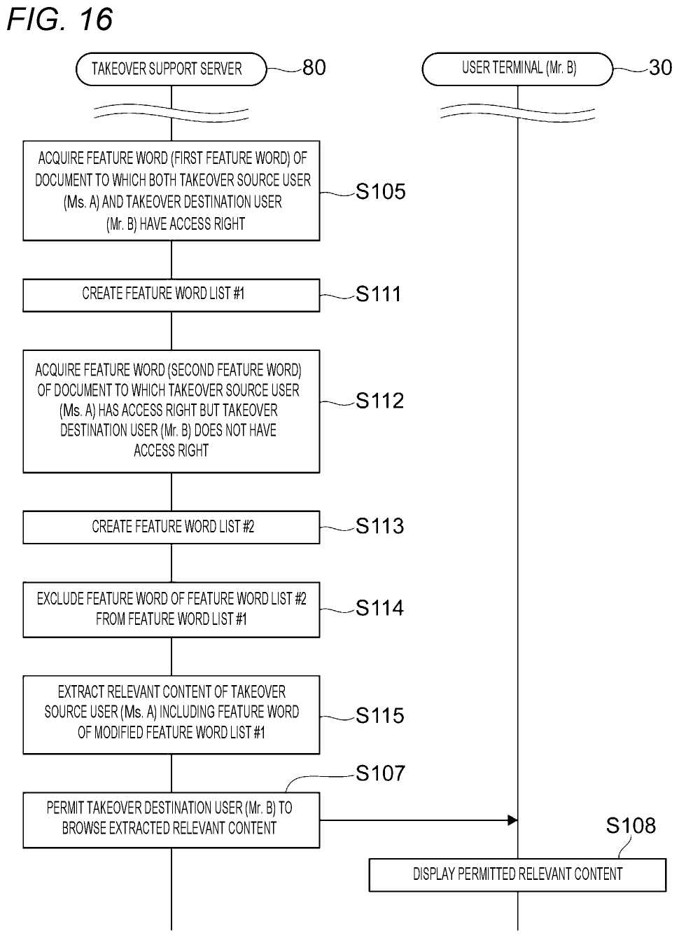

FIG. 16 is a diagram illustrating a processing operation related to task takeover in the second exemplary embodiment. In FIG. 16, elements corresponding to those in FIG. 5 are denoted by the corresponding reference numerals.

In FIG. 16, in the processing operation illustrated in FIG. 5, only the user terminal 30 operated by Mr. B as the takeover destination user, and the takeover support server 80 are illustrated. Further, in FIG. 16, only the processing characteristic of the user terminal 30 and the takeover support server 80 in the present exemplary embodiment is illustrated.

The description of FIG. 16 starts from the processing operation of step 105 by the takeover support server 80. That is, the takeover support server 80 acquires a feature word of a document to which both the takeover source user and the takeover destination user have the access right. After that, the takeover support server 80 creates the feature word list #1 (step 111).

Next, the takeover support server 80 acquires a feature word of a document to which the takeover source user has the access right but the takeover destination user does not have the access right (step 112). The feature word here is the “second feature word”.

After that, the takeover support server 80 creates the feature word list #2 (step 113). When the two types of feature word lists are created, the takeover support server 80 excludes the feature words of the feature word list #2 from the feature word list #1 (step 114).

Next, the takeover support server 80 extracts the relevant contents of the takeover source user including the feature words of the modified feature word list #1 (step 115).

After that, the takeover support server 80 permits the takeover destination user to browse the extracted relevant contents (step 107).

The permitted relevant contents are transmitted from the takeover support server 80 to the user terminal 30. As a result, the user terminal 30 displays the permitted relevant contents on the display (step 108).

### Specific Example

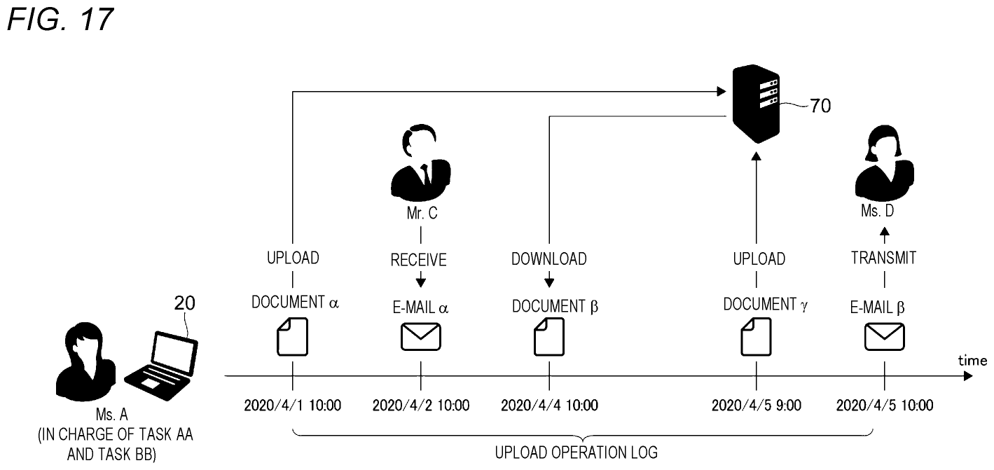

Hereinafter, a specific example of the processing operation described with reference to FIG. 16 will be described with reference to FIGS. 17 to 23.

FIG. 17 is a diagram illustrating an example of an operation log recorded for Ms. A who is in charge of the task AA and the task BB. In FIG. 17, elements corresponding to those in FIG. 6 are denoted by the same reference numerals.

In FIG. 17, a document γ uploaded by Ms. A to the document management server 70 at 9:00 on Apr. 5, 2020 is added.

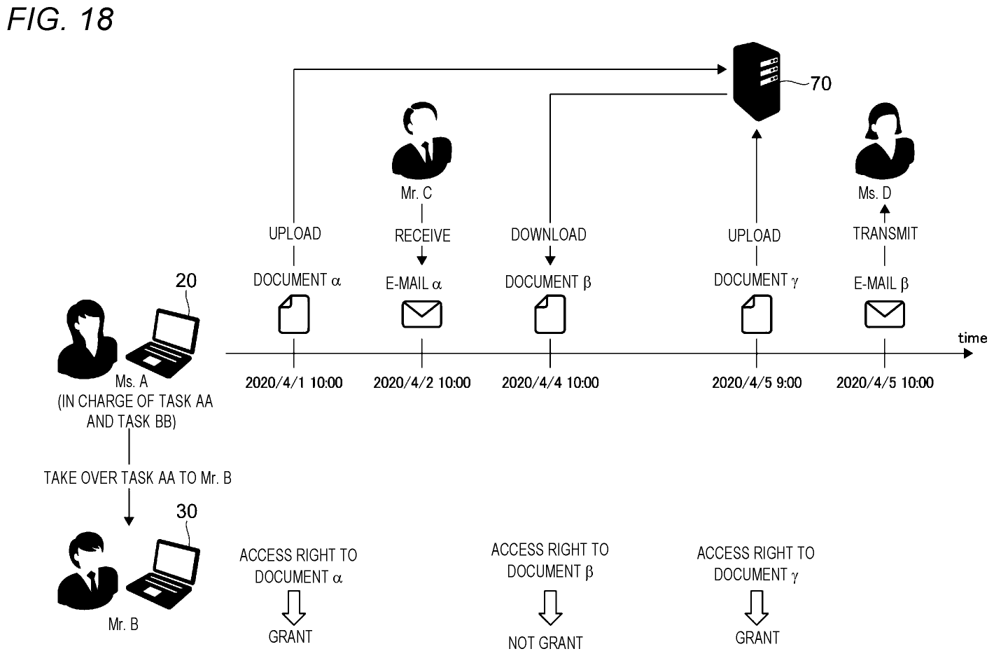

FIG. 18 is a diagram illustrating a scene in which one of tasks that Ms. A is in charge of is taken over to Mr. B. In FIG. 18, elements corresponding to those in FIG. 9 are denoted by the same reference numerals.

Also, in the case of FIG. 18, of the task AA and the task BB that Ms. A is in charge of, only the task AA is taken over to Mr. B.

With this takeover, Mr. B is granted with the access right to the document α and the document γ related to the task AA. Meanwhile, the access right of the document β relevant to the task BB is not granted to Mr. B.

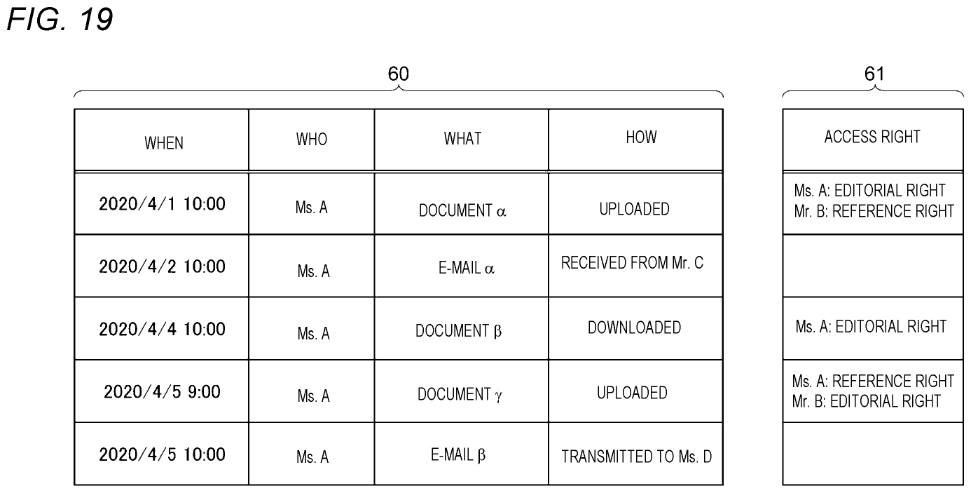

FIG. 19 is a diagram illustrating the relationship between a document and an access right after the task takeover. In FIG. 19, elements corresponding to those in FIG. 10 are denoted by the same reference numerals.

In FIG. 19, the content of an access right 61 granted to a user will be described in association with the operation log stored in the operation log server 60.

In the case of FIG. 19, the document α is granted with the “editorial right” to Ms. A and the “reference right” to Mr. B.

Meanwhile, the document β is granted with the “editorial right” only to Ms. A. This is because the task BB is not to be taken over to Mr. B.

Further, the document γ is granted with the “reference right” to Ms. A and the “editorial right” to Mr. B.

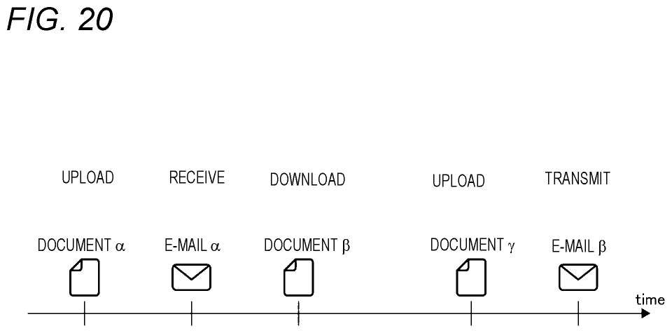

FIG. 20 is a diagram illustrating documents and contents related to Ms. A's operation log. In FIG. 20, elements corresponding to those in FIG. 18 are denoted by the same reference numerals.

In the present exemplary embodiment, the operation log includes five operations: two “upload” operations, one “download” operation, one “receive e-mail” operation, and one “transmit e-mail” operation.

Further, the document α, the document β, and the document γ are illustrated as corresponding documents, and the e-mail α and the e-mail R are illustrated as corresponding contents.

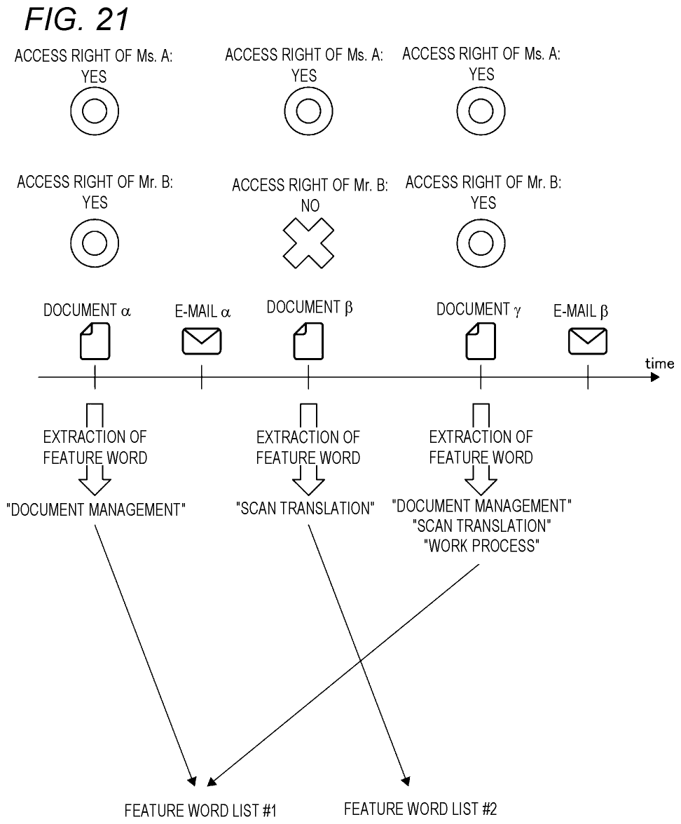

FIG. 21 is a diagram illustrating a state in which a feature word is extracted from the document α, the document β, and the document γ to which Ms. A as the takeover source user has the access right.

“Document management” is extracted as a feature word from the document α.

“Scan translation” is extracted as a feature word from the document β.

“Document management”, “scan translation”, and “work process” are extracted as feature words from the document γ.

The feature words extracted from the document α and the document γ to which both Ms. A and Mr. B have the access right are aggregated in the feature word list #1.

Meanwhile, the feature word extracted from the document β to which only Ms. A has the access right and Mr. B does not have the access right is recorded as the feature word list #2.

In FIG. 21, the relationship between the feature words extracted from the documents, and the feature word list are associated by arrows.

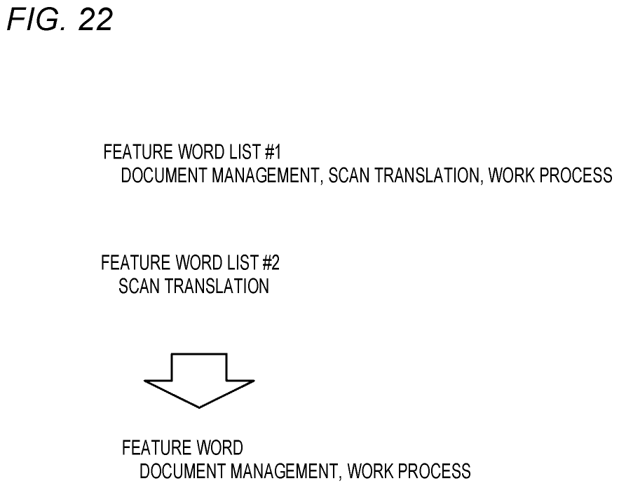

FIG. 22 is a diagram illustrating the relationship between a feature word list and a feature word used for extracting the relevant contents.

The feature word list #1 corresponding to the feature word of the document α and the feature word of the document γ includes “document management”, “scan translation”, and “work process”.

The feature word list #2 corresponding to the feature word of the document β includes “scan translation”.

In the present exemplary embodiment, the feature word of the feature word list #2 is excluded from the feature word list #1. As a result, two feature words remain: “document management” and “work process”.

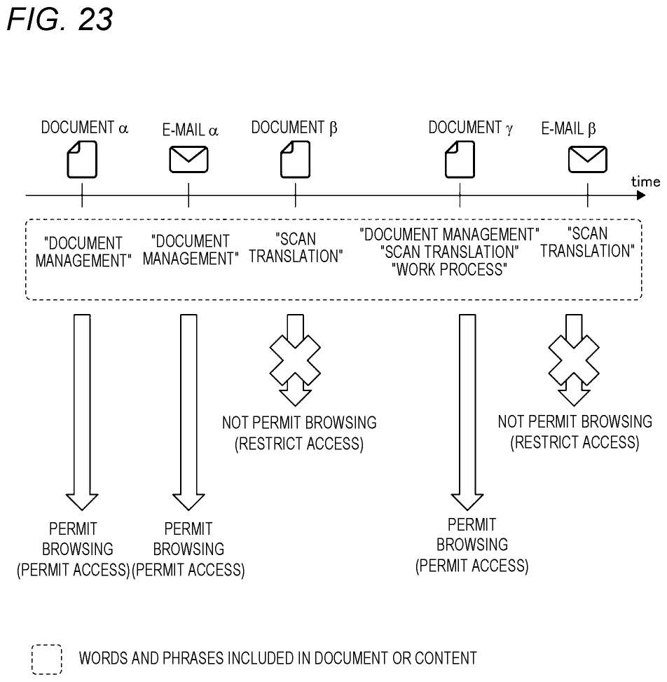

FIG. 23 is a diagram illustrating control of browsing of the relevant contents. In the case of FIG. 23, among the documents and the contents to which Ms. A has the access right, the browsing of the document α, the e-mail α, and the document γ including “document management” and “work process” is permitted. Meanwhile, the browsing of the document β and the e-mail β that do not include “document management” and “work process” is prohibited.

In the case of the method of the first exemplary embodiment, all the documents and the contents including the words and phrases in the feature word list #1 are extracted as the relevant contents. That is, the document and the contents including “scan translation” are also extracted as the relevant contents. As a result, the document β and the e-mail β that does not need to be seen or should not be seen to Mr. B is also included in the relevant contents.

However, in the present exemplary embodiment, since the words and phrases in the feature word list #2 are excluded from the feature word list #1, the document β and the e-mail β do not need to be included in the relevant contents.

### Third Exemplary Embodiment

The present exemplary embodiment also assumes the information processing system 1 illustrated in FIG. 1.

The present exemplary embodiment is different from the first and second exemplary embodiments in terms of a part of the functions of the takeover support server 80 (see, e.g., FIG. 1).

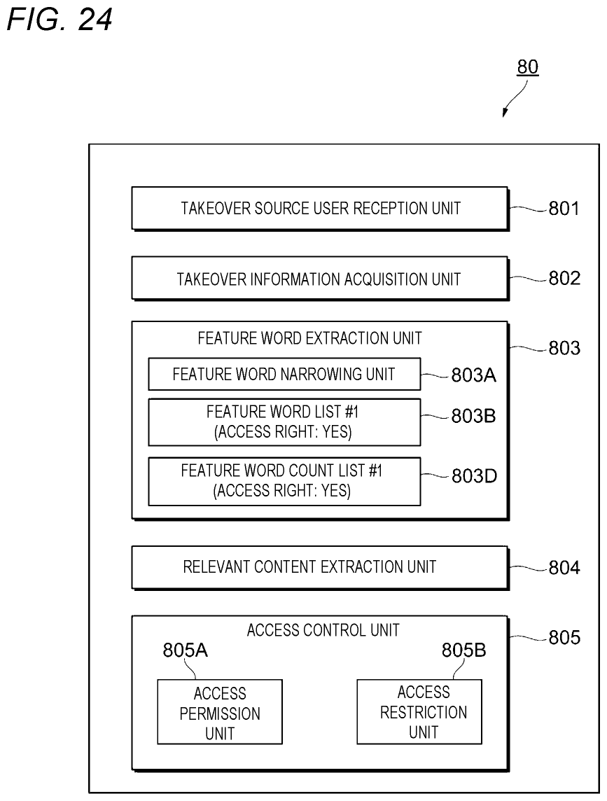

FIG. 24 is a diagram illustrating the functional configuration of the takeover support server 80 used in the third exemplary embodiment. In FIG. 24, elements corresponding to those in FIG. 15 are denoted by the corresponding reference numerals.

In the case of the takeover support server 80 used in the present exemplary embodiment, the feature word extraction unit 803 is provided with the feature word narrowing unit 803A, the feature word list 803B, and a feature word count list 803D. That is, the feature word extraction unit 803 in the present exemplary embodiment is provided with the feature word count list 803D instead of the feature word list 803C.

Further, the feature word list 803B is a list of feature words extracted from a document to which both Ms. A as the takeover source and Mr. B as the takeover destination, have the access right, that is, the feature word list #1.

The feature word count list 803D is a list of the number of extracted feature words that appear from a set of documents to which both Ms. A as the takeover source and Mr. B as the takeover destination, have the access right (hereinafter, referred as a “feature word count list #1”).

The feature word narrowing unit 803A in the present exemplary embodiment calculates the ratio of the number of occurrences of each of feature words to the total number of occurrences of the feature words extracted from the set of documents to which both Ms. A as the takeover source and Mr. B as the takeover destination, have the access right, and excludes from the feature word list 803B when the calculated ratio is less than or equal to a predetermined value.

In the present exemplary embodiment, it is regarded that the feature words whose occurrence ratio is less than or equal to the predetermined value are unlikely to represent the feature of a document to be taken over.

In the present exemplary embodiment, the predetermined value is set to 30% of the total number of occurrences. The value used for determination may be another value. For example, the value may be 20%.

The feature word narrowing unit 803A excludes words and phrases having a relatively low occurrence ratio from the feature word list #1 so that documents and contents having low relevance are not extracted as the relevant contents.

In the case of the first exemplary embodiment, the relevant contents are extracted by using the first feature word as it is, but when the second feature word is included in the first feature word, a document to which Mr. B does not have the access right or the contents relevant to the document may be included in the relevant contents.

However, in the present exemplary embodiment, it is possible to exclude the document to which Mr. B does not have the access right and its relevant contents from the takeover information of Mr. B.

### <Processing Operation>

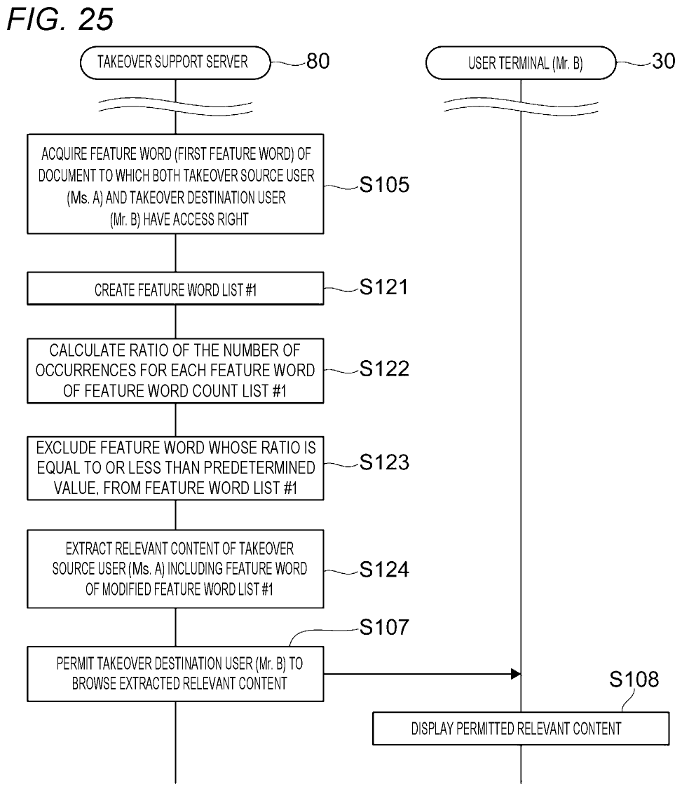

FIG. 25 is a diagram illustrating a processing operation related to task takeover in the third exemplary embodiment. In FIG. 25, elements corresponding to those in FIG. 5 are denoted by the same reference numerals.

In FIG. 25, in the processing operation illustrated in FIG. 5, only the user terminal 30 operated by Mr. B as the takeover destination user and the takeover support server 80 are illustrated. Further, in FIG. 25, only the processing characteristic of the user terminal 30 and the takeover support server 80 in the present exemplary embodiment is illustrated.

The description of FIG. 25 starts from the processing operation of step 105 by the takeover support server 80. That is, the description starts from the point of time when the takeover support server 80 acquires the feature word of the document to which both the takeover source user and the takeover destination user have the access right.

After that, the takeover support server 80 counts the number of occurrences of feature words extracted from a set of target documents, and creates the feature word count list #1 (step 121).

Next, the takeover support server 80 calculates the occurrence ratio for each feature word in the feature word count list #1 (step 122).

Subsequently, the takeover support server 80 excludes a feature word whose occurrence ratio is equal to or less than a predetermined value from the feature word list #1 (step 123).

Further, the takeover support server 80 extracts the relevant contents of the takeover source user including the feature words in the modified feature word list #1 (step 124).

After that, the takeover support server 80 permits the takeover destination user to browse the extracted relevant contents (step 107).

The permitted relevant contents are transmitted from the takeover support server 80 to the user terminal 30. As a result, the user terminal 30 displays the permitted relevant contents on the display (step 108).

### Specific Example

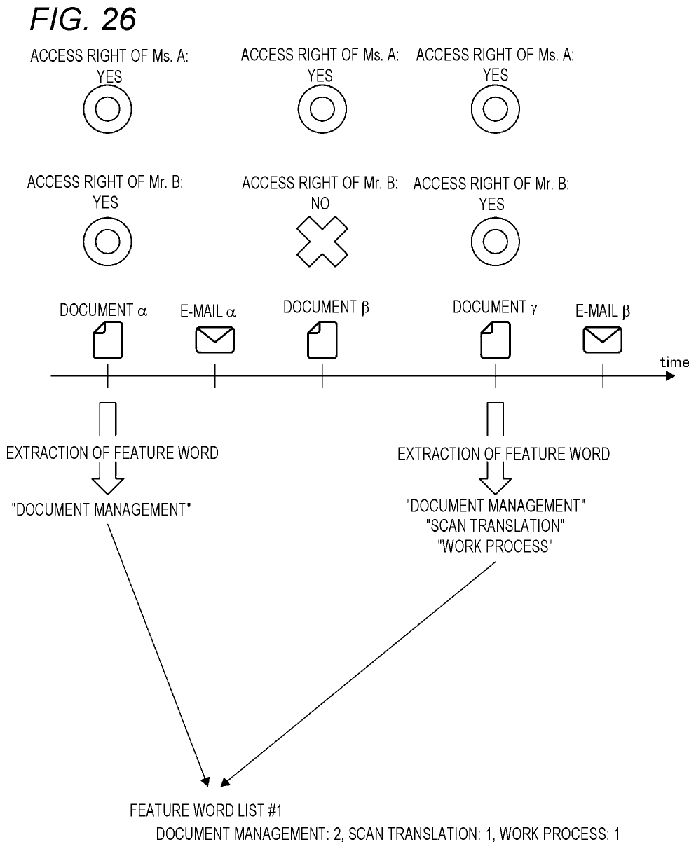

Hereinafter, a specific example of the processing operation described with reference to FIG. 25 will be described with reference to FIGS. 26 to 28.

FIG. 26 is a diagram illustrating a state in which the feature word count list #1 is created from the document α and the document γ to which both Ms. A as the takeover source user and Mr. B as the takeover destination user have the access right.

In the case of FIG. 26, “document management” is extracted as a feature word of the document α, and “document management”, “scan translation”, and “work process” are extracted as the feature of the document γ.

In the case of FIG. 26, in the set of the document α and the document γ, “document managements” appears twice, and each of “scan translation” and “work process” appears once.

The total number of feature words appearing in the set is four. Therefore, the ratio of the number of occurrences of “document management” in the set is 2/4, that is, 50%. Meanwhile, the ratio of the number of occurrences of “scan translation” and “work process” is ¼, that is, 25%.

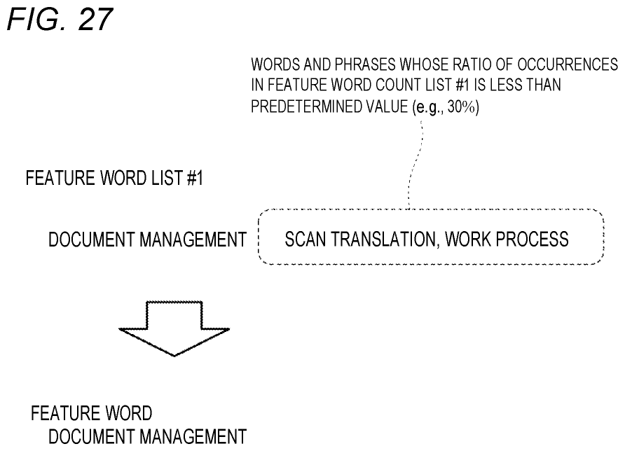

FIG. 27 is a diagram illustrating a specific example of narrowing down by the feature word narrowing unit 803A.

“Document management”, “scan translation”, and “work process” are registered in the feature word list #1, but “document management” is the only feature word whose occurrence ratio is 30% or more.

Therefore, the only feature word after narrowing down by the feature word narrowing unit 803A is “document management”.

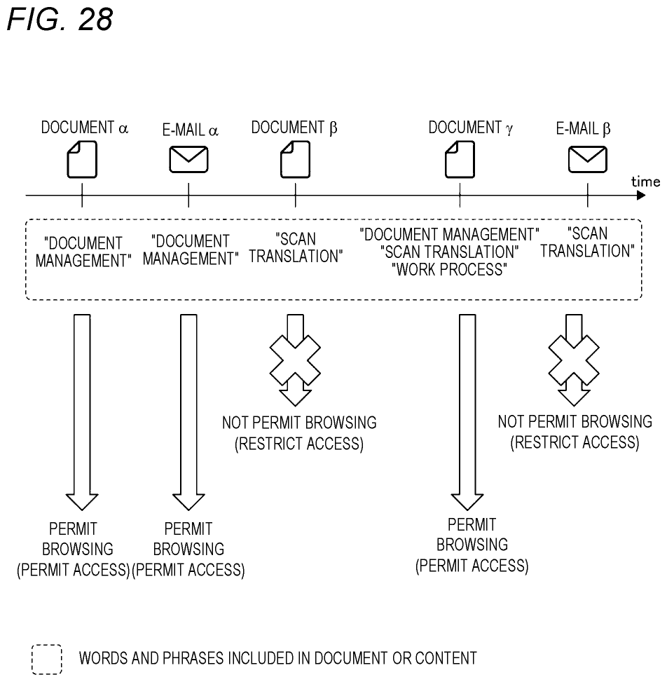

FIG. 28 is a diagram illustrating control of browsing of the relevant contents. In the case of FIG. 28, among the documents and the contents to which Ms. A has the access right, the browsing of the document α, the e-mail α, and the document γ including “document management” is permitted. Meanwhile, the browsing of the document β and the e-mail β that do not include “document management” is prohibited.

In the case of the method of the first exemplary embodiment, all the documents and the contents including the words and phrases in the feature word list #1 are extracted as the relevant contents. That is, the documents and the contents including “scan translation” and “work process” are also extracted as the relevant contents. As a result, the document β and the e-mail β that does not need to be seen or should not be seen to Mr. B is also included in the relevant contents.

However, in the present exemplary embodiment, since the words and phrases whose ratio of the number of occurrences is less than or equal to the predetermined value are excluded from the words and phrases included in the feature word list #1, the document β and the e-mail β are not included in the relevant contents.

### Fourth Exemplary Embodiment

The present exemplary embodiment also assumes the information processing system 1 illustrated in FIG. 1.

The present exemplary embodiment is different from the above-described exemplary embodiments in terms of a part of the functions of the takeover support server 80 (see, e.g., FIG. 1).

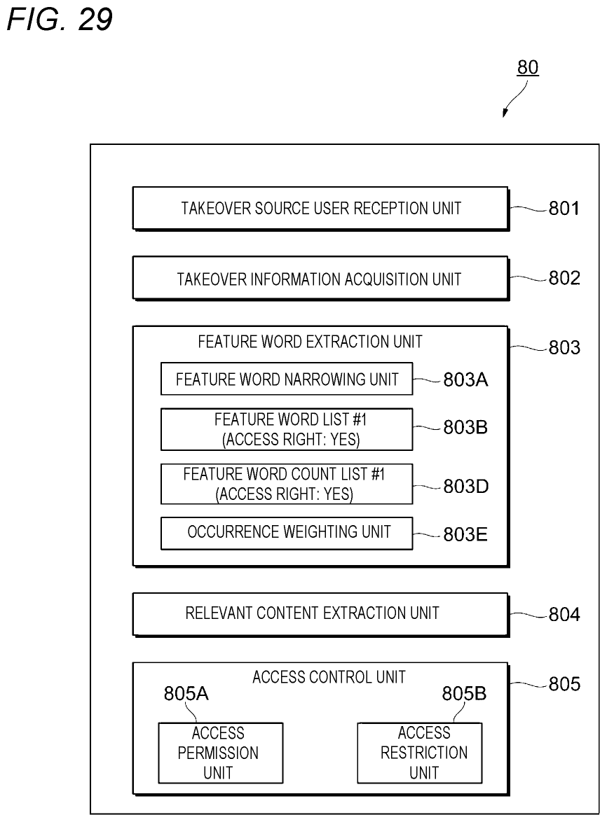

FIG. 29 is a diagram illustrating the functional configuration of the takeover support server 80 used in the fourth exemplary embodiment. In FIG. 29, elements corresponding to those in FIG. 24 are denoted by the same reference numerals.

In the case of the takeover support server 80 used in the present exemplary embodiment, the feature word extraction unit 803 is provided with a feature word narrowing unit 803A, a feature word list 803B, a feature word count list 803D, and an occurrence weighting unit 803E. That is, the occurrence weighting unit 803E is added to the feature word extraction unit 803 in the present exemplary embodiment.

The occurrence weighting unit 803E multiplies the number of occurrences of the feature word by a weight according to a time difference between the date and time when the access right is granted to Mr. B as the takeover destination user and the current time. This function adjusts the ratio of the number of occurrences of each feature word to the total number of occurrences.

For example, it is possible to adjust the number of occurrences to be larger than the real number for the feature word of a document in which the date and time when the access right is granted to Mr. B is closer to the current time. In this case, it is easy to extract other documents and contents relevant to the content of a new document to which the access right is granted, as the relevant contents.

On the contrary, it is possible to adjust the number of occurrences to be smaller than the real number for the feature word of the document in which the date and time when the access right is granted to Mr. B is farther from the current time. In this case, it is difficult to extract the documents or contents relevant to the content of an old document to which the access right is granted, as the relevant contents.

The weighting rule described above is an example. Contrary to the above example, it is possible to adjust the number of occurrences to be smaller for the feature word of the document in which the date and time when the access right is granted is closer to the current time, and it is possible to adjust the number of occurrences to be larger for the feature word of the document in which the date and time when the access right is granted is farther from the current time.

The value of the weight may be changed linearly or non-linearly according to a time difference from the current time. For example, it may be changed logarithmically or exponentially.

Further, the time difference from the current time may be divided into plural periods, and individual weights may be set for each period.

In the present exemplary embodiment, the weight is changed according to whether the time difference between the time when the access right to Mr. B is changed and the current time is within one day or exceeds one day. Specifically, the weight is set to “2” when the time difference is within one day, and the weight is set to “1” when the time difference exceeds one day.

### <Processing Operation>

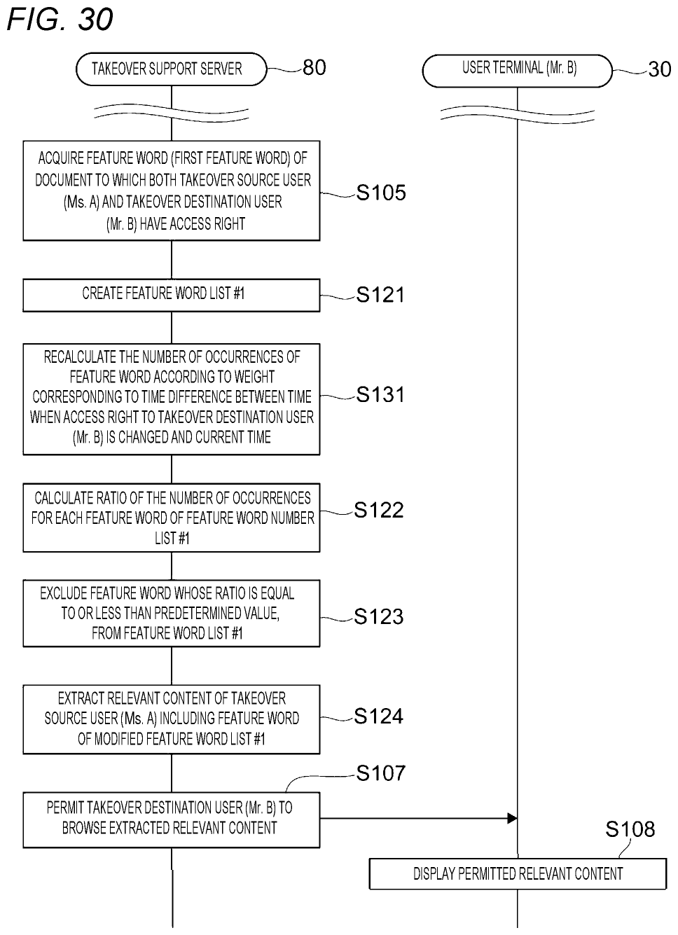

FIG. 30 is a diagram illustrating a processing operation related to task takeover in the fourth exemplary embodiment. In FIG. 30, elements corresponding to those in FIG. 25 are denoted by the same reference numerals.

In FIG. 30, only the processing characteristic of the user terminal 30 and the takeover support server 80 in the present exemplary embodiment is illustrated.

The description of FIG. 30 starts from the processing operation of step 105 by the takeover support server 80. That is, the description starts from the point of time when the takeover support server 80 acquires the feature word of the document to which both the takeover source user and the takeover destination user have the access right.

After that, the takeover support server 80 counts the number of occurrences of feature words extracted from a set of target documents, and creates the feature word count list #1 (step 121).

Next, the takeover support server 80 recalculates the number of occurrences of the feature word according to the weight corresponding to the time difference between the time when the access right to the takeover destination user is changed and the current time (step 131).

After that, the takeover support server 80 calculates the occurrence ratio for each feature word in the feature word count list #1 (step 122).

Subsequently, the takeover support server 80 excludes a feature word whose occurrence ratio is equal to or less than a predetermined value from the feature word list #1 (step 123).

Further, the takeover support server 80 extracts the relevant contents of the takeover source user including the feature words in the modified feature word list #1 (step 124).

After that, the takeover support server 80 permits the takeover destination user to browse the extracted relevant contents (step 107).

The permitted relevant contents are transmitted from the takeover support server 80 to the user terminal 30. As a result, the user terminal 30 displays the permitted relevant contents on the display (step 108).

### Specific Example

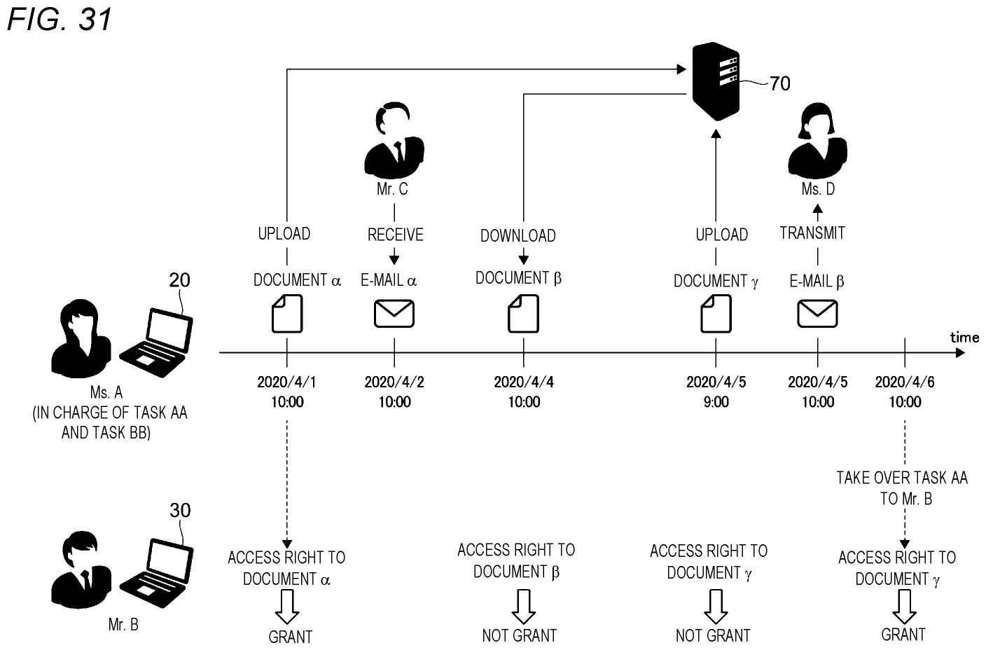

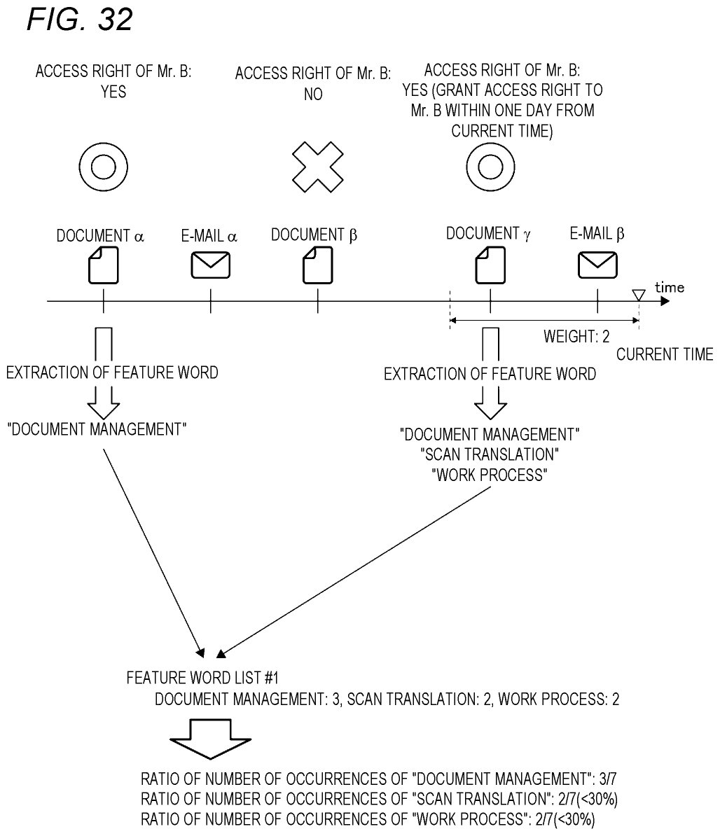

Hereinafter, a specific example of the processing operation described with reference to FIG. 30 will be described with reference to FIGS. 31 and 32.

FIG. 31 is a diagram illustrating a scene in which one of tasks that Ms. A is in charge of is taken over to Mr. B. In FIG. 31, elements corresponding to those in FIG. 18 are denoted by the same reference numerals.

In the case of FIG. 31, at the point of time when the document α is uploaded to the document management server 70, Mr. B is also granted with the access right to the document α.

Meanwhile, at the point of time when the document γ is uploaded to the document management server 70, Mr. B is not granted with the access right to the document γ. The access right to the document γ is granted to Mr. B after one or more days have passed since the document γ was uploaded to the document management server 70. In the present exemplary embodiment, the task AA is taken over to Mr. B at this date and time.

FIG. 32 is a diagram illustrating a state in which the feature word count list #1 is created from the document α and the document γ to which both Ms. A as the takeover source user and Mr. B as the takeover destination user have the access right.

In FIG. 32, elements corresponding to those in FIG. 26 are denoted by the same reference numerals.

In the case of FIG. 32, the time when the access right to the document γ is granted to Mr. B is within one day from the current time.

Therefore, “2” is used as the weight. That is, the number of occurrences of the feature word included in the document γ is doubled.

Therefore, the number of occurrences of the feature word in the feature word count list #1 in FIG. 32 is different from that of the feature word count list #1 illustrated in FIG. 26.

Specifically, in the set of the document α and the document γ, “document management” is regarded to appear three times, and each of “scan translation” and “work process” is regarded to appear twice. In this case, the total number of feature words appearing in the set is regarded to be seven.

As a result, the ratio of the number of occurrences of “document management” in the set is calculated to be 3/7. Meanwhile, the ratio of the number of occurrences of “scan translation” and “work process” is calculated to be 2/7. In the case of this example, the ratio of the number of occurrences of “scan translation” and “work process” is less than 30%.

Therefore, also in the present exemplary embodiment, the feature word remaining in the feature word list #1 is only “document management” as in the third exemplary embodiment.

Therefore, Mr. B is permitted to browse the document α, the e-mail α, and the document γ, but is not permitted to browse the document β and the e-mail β.

When the feature words extracted from the document γ are “document management” and “scan translation”, the conclusion will change.

In this case, in the set of the document α and the document γ, “document management” is regarded to appear three times, and “scan translation” is regarded to appear twice. In this case, the total number of feature words appearing in the set is regarded to be five.

As a result, the ratio of the number of occurrences of “document management” in the set is calculated to be ⅗. Meanwhile, the ratio of the number of occurrences of “scan translation” is calculated to be ⅖. In the case of this example, there is no feature word whose ratio of the number of occurrences is less than 30%.

As a result, the document β and the e-mail β are added to the relevant contents that Mr. B is permitted to browse.

In the present exemplary embodiment, since the number of occurrences is adjustable by weighting, it is possible to include a document, an e-mail, and the like that are highly likely to be relevant to a feature word of interest, in the objects available for browsing, depending on the method of weighting.

### Fifth Exemplary Embodiment

The present exemplary embodiment also assumes the information processing system 1 illustrated in FIG. 1.

The present exemplary embodiment is different from the above-described exemplary embodiments in terms of a part of the functions of the takeover support server 80 (see, e.g., FIG. 1).

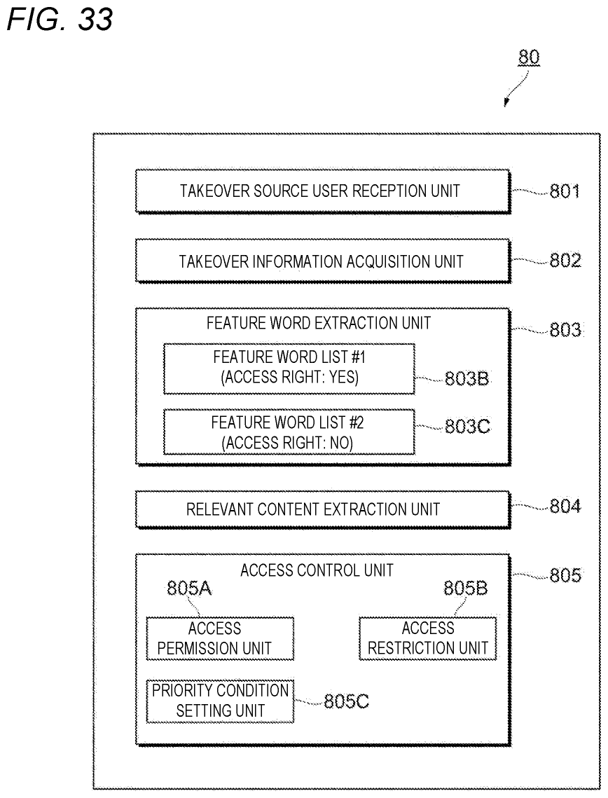

FIG. 33 is a diagram illustrating the functional configuration of the takeover support server 80 used in the fifth exemplary embodiment. In FIG. 33, elements corresponding to those in FIG. 24 are denoted by the same reference numerals.

In the case of the takeover support server 80 used in the present exemplary embodiment, the feature word extraction unit 803 is provided with feature word lists 803B and 803C, and the access control unit 805 is provided with the access permission unit 805A, the access restriction unit 805B, and a priority condition setting unit 805C.

The feature word list 803B mentioned here is a list of feature words extracted from a document to which both Ms. A as the takeover source and Mr. B as the takeover destination, have the access right. That is, the feature word list 803B is the feature word list #1 including first feature words.

Meanwhile, the feature word list 803C is a list of feature words extracted from a document in which Ms. A as the takeover source has the access right, but Mr. B as the takeover destination does not have the access right. That is, the feature word list 803C is the feature word list #2 including second feature words.

In the case of the second exemplary embodiment described above, the relevant contents were extracted after preprocessing for excluding the second feature word from the feature word list #1. That is, the extracted relevant contents did not include a document or the contents including the second feature word.

Meanwhile, in the present exemplary embodiment, this type of preprocessing is not executed. Therefore, when the relevant contents including the first feature word constituting the feature word list #1 is extracted, both the first feature word and the second feature word might be included in the extracted relevant contents.

Therefore, in the present exemplary embodiment, the priority condition setting unit 805C is added to the access control unit 805 to control browsing of the relevant content including both the first feature word and the second feature word. That is, the priority condition setting unit 805C provides a function of setting the condition for controlling browsing of the extracted relevant contents.

In the present exemplary embodiment, the condition mentioned here is referred to as a “priority condition” in the sense of determining which of the permission for browsing by the first feature word and the restriction on browsing by the second feature word is prioritized.

The priority condition includes, for example, a setting that permits unconditional browsing when the first feature word is included, a setting that restricts unconditional browsing when the second feature word is included, a setting that permits browsing when the first feature word whose ratio of the number of occurrences in the set of first documents is higher than a predetermined value is included, and a setting that restricts browsing when the first feature word whose ratio of the number of occurrences in the set of first documents is higher than the predetermined value is not included.

### <Processing Operation>

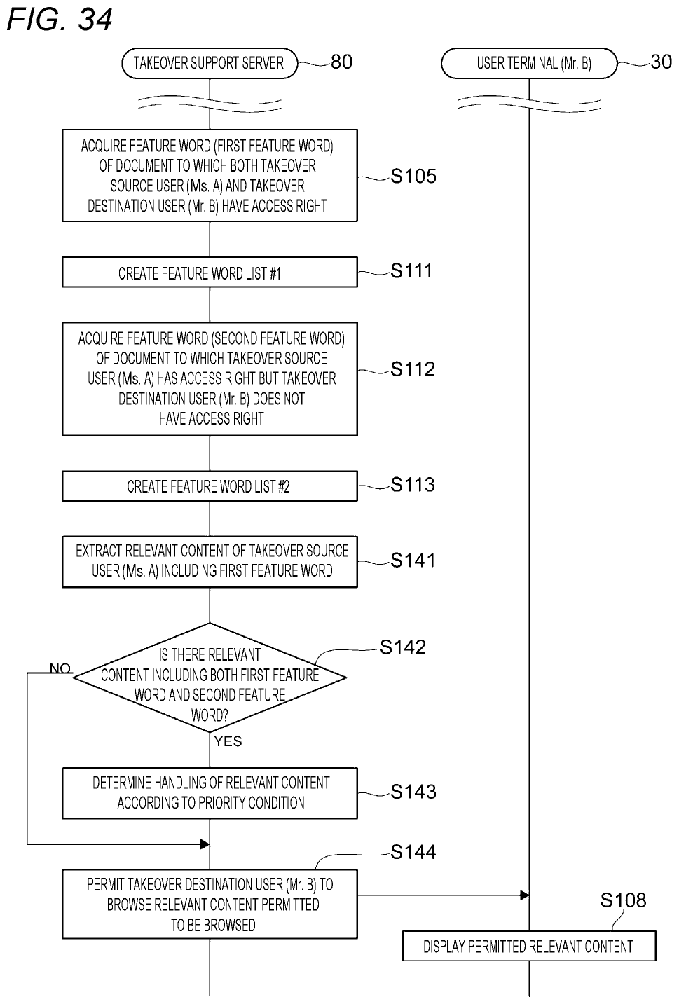

FIG. 34 is a diagram illustrating the processing operation related to task takeover in the fifth exemplary embodiment. In FIG. 34, elements corresponding to those in FIG. 16 are denoted by the same reference numerals.

In FIG. 34, only the processing characteristic of the user terminal 30 and the takeover support server 80 in the present exemplary embodiment is illustrated.

The description of FIG. 34 starts from the processing operation of step 105 by the takeover support server 80. That is, the takeover support server 80 acquires a feature word of a document to which both the takeover source user and the takeover destination user have the access right.

After that, the takeover support server 80 creates the feature word list #1 (step 111). The feature word list #1 is a list of first feature words.

Next, the takeover support server 80 acquires a feature word of a document to which the takeover source user has the access right but the takeover destination user does not have the access right (step 112).

After that, the takeover support server 80 creates the feature word list #2 (step 113). The feature word list #2 is a list of second feature words.

When the two types of feature word lists are created, the takeover support server 80 extracts the relevant contents of the takeover source user including the first feature word (step 141).

Next, the takeover support server 80 determines whether there is a relevant content including both the first feature word and the second feature word (step 142).

For the relevant content including the second feature word among the relevant contents extracted in step 141, an affirmative result is obtained in step 142 and the process proceeds to step 143.

Meanwhile, among the relevant contents extracted in step 141, for the relevant content not including the second feature word, a negative result is obtained in step 142 and the process proceeds to step 144.

When the process proceeds to step 143, the takeover support server 80 determines the handling of the corresponding relevant contents according to the priority condition. That is, the takeover support server 80 determines whether to permit or restrict browsing of the corresponding relevant contents.

After this, the takeover support server 80 proceeds to step 144.

The takeover support server 80 that proceeded to step 144 permits the takeover destination user to browse the relevant contents that are permitted to be browsed.

The permitted relevant contents are transmitted from the takeover support server 80 to the user terminal 30. As a result, the user terminal 30 displays the permitted relevant contents on the display (step 108).

### Specific Example

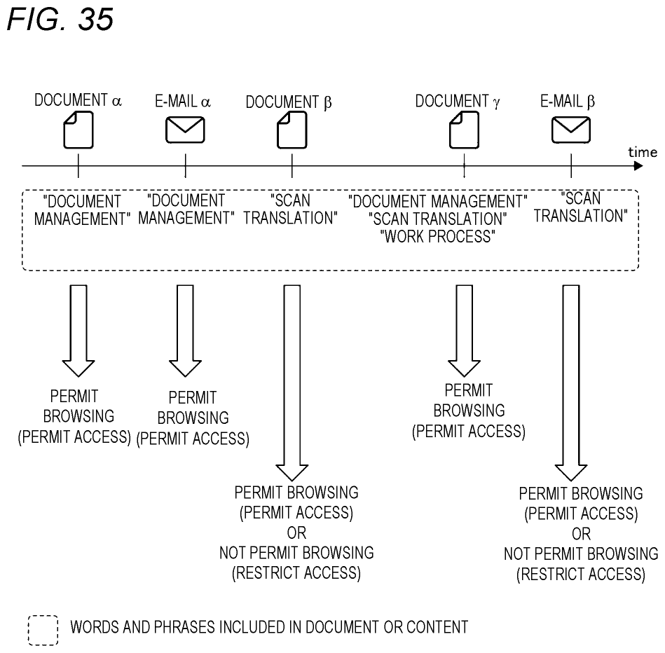

Hereinafter, a specific example of the processing operation described with reference to FIG. 34 will be described with reference to FIG. 35.

FIG. 35 is a diagram illustrating control of browsing of the relevant contents. In FIG. 35, elements corresponding to those in FIG. 23 are denoted by the same reference numerals.

In the present exemplary embodiment, the first feature words are “document management”, “scan translation”, and “work process”. Therefore, both the document β and the e-mail β are included in the relevant contents in step 141 (see FIG. 34).

However, the feature words extracted from the document β and the e-mail β are also the second feature words to which the access right is not granted to Mr. B.

That is, the document β and the e-mail β are the document and the content including both the first feature word and the second feature word.

Therefore, in the present exemplary embodiment, a determination as to whether to permit browsing the document β and the e-mail β is made according to the priority condition.

Since a determination as to whether to permit browsing is made according to the priority condition, the documents and the contents that may be browsed vary when the details of the priority condition are changed.

The priority condition may be set by a user, or may be selected by the user from plural priority conditions.

### Other Exemplary Embodiments

(1) Although the exemplary embodiments of the present disclosure have been described above, the technical scope of the present disclosure is not limited to the scope described in the above-described exemplary embodiments. It is clear from the description of the claims that the above-described exemplary embodiments with various modifications or improvements are also included in the technical scope of the present disclosure.

(2) In the above-described exemplary embodiments, the functions of controlling whether the relevant contents for Mr. B may be browsed are aggregated in the takeover support server 80 (see FIG. 1), but all of the same functions may be provided in another terminal, or may be provided in plural terminals in a distributed manner.

For example, the function of the takeover support server 80 may be provided as a part of the function of the document management server 70, or may be provided as a part of the functions of the user terminals 20 and 30.
(3) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
extract a first feature word from a first document to which both a first user and a second user have an access right;
extract contents associated with an operation log of the first user; and
control access of the second user to the contents by using the first feature word.

2. The information processing apparatus according to claim 1, wherein the processor is configured to:
permit access of the second user to the content including the first feature word among the associated contents; and
restrict access of the second user to the content including a second feature word extracted from a second document to which the first user has an access right but the second user does not have an access right, among the associated contents.

3. The information processing apparatus according to claim 2, wherein the processor is configured to:
prioritize control of access based on the first feature word according to a predetermined condition, for the content including both the first feature word and the second feature word.

4. The information processing apparatus according to claim 3, wherein the predetermined condition is defined by a ratio of the number of occurrences of each of the first feature words to a total number of occurrences of the first feature words extracted from a set of the first documents.

5. The information processing apparatus according to claim 2, wherein the processor is configured to:
prioritize control of access based on the second feature word according to a predetermined condition, for the content including both the first feature word and the second feature word.

6. The information processing apparatus according to claim 1, wherein the processor is configured to:
calculate a ratio of the number of occurrences of each of the first feature words to a total number of occurrences of the first feature words extracted from a set of the first documents; and
extract the contents without using the first feature word whose ratio is equal to or less than a predetermined value.

7. The information processing apparatus according to claim 6, wherein the processor is configured to:
modify the number of occurrences of the first feature word according to a weight corresponding to a time when the access right of the second user to the first document is changed.

8. The information processing apparatus according to claim 1, wherein the processor is configured to:
exclude, from the first feature word, a second feature word extracted from a second document to which the first user has an access right but the second user does not have an access right; and
permit access of the second user to the contents including the first feature word after excluding the second feature word.

9. The information processing apparatus according to claim 1, wherein the processor is configured to:
present the contents to which access is permitted to the second user, in time series.

10. The information processing apparatus according to claim 2, wherein the processor is configured to:
present the contents to which access is permitted to the second user, in time series.

11. The information processing apparatus according to claim 3, wherein the processor is configured to:
present the contents to which access is permitted to the second user, in time series.

12. The information processing apparatus according to claim 4, wherein the processor is configured to:
present the contents to which access is permitted to the second user, in time series.

13. The information processing apparatus according to claim 5, wherein the processor is configured to:
present the contents to which access is permitted to the second user, in time series.

14. The information processing apparatus according to claim 6, wherein the processor is configured to:
present the contents to which access is permitted to the second user, in time series.

15. The information processing apparatus according to claim 7, wherein the processor is configured to:
present the contents to which access is permitted to the second user, in time series.

16. The information processing apparatus according to claim 8, wherein the processor is configured to:
present the contents to which access is permitted to the second user, in time series.

17. A non-transitory computer readable medium storing a program causing a computer to execute information processing, the information processing comprising:
extract a first feature word from a first document to which both a first user and a second user have an access right;
extract contents associated with an operation log of the first user; and
control access of the second user to the contents by using the first feature word.

18. An information processing apparatus comprising:
first extracting means for extracting a first feature word from a first document to which both a first user and a second user have an access right;
second extracting means for extracting contents associated with an operation log of the first user; and
controlling means for controlling access of the second user to the contents by using the first feature word.
